(19) United States
(12) Patent Application Publication
(10) Pub. No.: US 2023/0285895 A1
(43) Pub. Date: Sep. 14, 2023

(54) Gaseous CO2 Capture Systems for Improving Capture Performance, and Methods of Use Thereof

(71) Applicant: Blue Planet Systems Corporation, Los Gatos, CA (US)

(72) Inventors: Kyle Self, Los Gatos, CA (US); Jacob Schneider, San Jose, CA (US); Brent R. Constantz, Portola Valley, CA (US)

(21) Appl. No.: 18/118,002

(22) Filed: Mar. 6, 2023

Related U.S. Application Data
(63) Continuation-in-part of application No. PCT/US2022/045379, filed on Sep. 30, 2022.
(60) Provisional application No. 63/251,313, filed on Oct. 1, 2021.

(51) Int. Cl. B01D 53/62; B01D 53/14

(52) U.S. Cl. CPC B01D 53/62; B01D 53/1475; B01D 2252/103; B01D 2252/102; B01D 2257/504; B01D 2258/0233

(57) ABSTRACT

Gaseous CO₂ capture systems are provided. Systems of interest include a plurality of gaseous CO₂ sources and at least one common CO₂ capture constraining element shared by the plurality of CO₂ sources. The subject systems are configured to improve at least one gaseous CO₂ capture performance metric relative to a suitable control. Gaseous CO₂ capture systems involving power plants, industrial plants, common mineralization capture system feed sources, common electrical grids, and common building material producers are also provided.

### CROSS-REFERENCE TO RELATED APPLICATION

This application is a continuation-in-part application of international application serial no. PCT/US2022/045379 filed Sep. 30, 2022, which application, pursuant to 35 U.S.C. § 119(e), claims priority to the filing date of U.S. Provisional Application Ser. No. 63/251,313 filed on Oct. 1, 2021; the disclosure of which applications are herein incorporated by reference.

### INTRODUCTION

Carbon dioxide (CO₂) is a naturally occurring chemical compound that is present in Earth's atmosphere as a gas. Sources of atmospheric CO₂ are varied, and include humans and other living organisms that produce CO₂ in the process of respiration, as well as other naturally occurring sources, such as volcanoes, hot springs, and geysers.

Additional major sources of atmospheric CO₂ include industrial plants. Many types of industrial plants (including cement plants, refineries, steel mills and power plants) combust various carbon-based fuels, such as fossil fuels and syngases. Fossil fuels that are employed include coal, natural gas, oil, petroleum coke and biofuels. Fuels are also derived from tar sands, oil shale, coal liquids, and coal gasification and biofuels that are made via syngas.

The environmental effects of CO₂ are of significant interest. CO₂ is commonly viewed as a greenhouse gas. The phrase “global warming” is used to refer to observed and continuing rise in the average temperature of Earth's atmosphere and oceans since the late 19th century. Because human activities since the industrial revolution have rapidly increased concentrations of atmospheric CO₂, anthropogenic CO₂ has been implicated in global warming and climate change, as well as increasing oceanic bicarbonate concentration. Ocean uptake of fossil fuel CO₂ is now proceeding at about 1 million metric tons of CO₂ per hour. Since the early 20th century, the Earth's mean surface temperature has increased by about 0.8° C. (1.4° F.), with about two-thirds of the increase occurring since 1980.

The effects of global warming on the environment and for human life are numerous and varied. Some effects of recent climate change may already be occurring. Rising sea levels, glacier retreat, Arctic shrinkage, and altered patterns of agriculture are cited as direct consequences, but predictions for secondary and regional effects include extreme weather events, an expansion of tropical diseases, changes in the timing of seasonal patterns in ecosystems, and drastic economic impact.

Projected climate changes due to global warming have the potential to lead to future large-scale and possibly irreversible effects at continental and global scales. The likelihood, magnitude, and timing is uncertain and controversial, but some examples of projected climate changes include significant slowing of the ocean circulation that transports warm water to the North Atlantic, large reductions in the Greenland and Western Antarctic Ice Sheets, accelerated global warming due to carbon cycle feedbacks in the terrestrial biosphere, and releases of terrestrial carbon from permafrost regions and methane from hydrates in coastal sediments.

While a matter of scientific debate, it is believed that excess atmospheric CO₂ is a significant contributing factor to global warming. Since the beginning of the Industrial Revolution, the concentration of CO₂ has increased by about 100 parts-per-million (ppm) (i.e., from 280 ppm to 380 ppm), and was recently observed to reach an average daily value of over 400 ppm. As such, there is great interest in the sequestration of CO₂, particularly in a manner sufficient to at least ameliorate the ever-increasing amounts of anthropogenic CO₂ that is present in the atmosphere.

Concerns over anthropogenic climate change and ocean acidification, have fueled an urgency to discover scalable, cost effective, methods of carbon capture and sequestration (CCS). Typically, methods of CCS separate pure CO₂ from complex flue streams, compress the purified CO₂, and finally inject it into underground saline reservoirs for geologic sequestration. These multiple steps are very energy and capital intensive. Carbonate mineralization is another method to sequester large amounts of CO₂, in gigaton (Gt, i.e., 1,000,000,000 tons) volumes, sustainably. Prior CCS approaches have involved the production of pure CO₂ for liquefaction and subsurface storage. For example, FIG. 7 depicts a known configuration 700 including a plant 701 that uses a conventional CCS system 702 to produce pure CO₂ for liquefaction and subsurface storage 705. CO₂ captured from a plant 701 using the CCS system 702 goes through a cooler/compressor 703. Following the cooling process, a liquefied CO₂ stream is transported by CO₂ pipeline 704 to subsurface storage 705.

### SUMMARY

While systems and methods for carbon capture and sequestration have improved in recent years, the present inventors have realized that the efficiency and efficacy with which these systems operate must increase before such technologies are more widely adopted. For example, the inventors discovered that conventional CCS systems such as those discussed above with respect to FIG. 7 are associated with certain inefficiencies such as high parasitic load. Accordingly, systems and methods configured to increase at least one gaseous CO₂ capture performance metric are desirable. The systems and methods of the present disclosure satisfy this desire.

Aspects of the invention include gaseous CO₂ capture systems. Systems of interest include a plurality of gaseous CO₂ sources, and at least one common CO₂ capture constraining element shared by the plurality of CO₂ sources. In addition, the present systems are configured to improve at least one gaseous CO₂ capture performance metric relative to a suitable control. In certain cases, the plurality of gaseous CO₂ sources comprises gaseous CO₂ sources selected from CO₂ gas point source emitters and CO₂ gas direct air capture (DAC) sources. CO₂ gas point emitters include, for example, power plants, cement plants, smelters, refineries and chemical plants. Common CO₂ capture constraining elements of interest include, for example, availability of CO₂ capture liquid, proximity to a common location, access to a common transportation chain (such as a pipeline network), proximity to a mineralized product distribution center, power (e.g., renewable power) usage from a common grid, or a combination thereof. Gaseous CO₂ capture protocols employed by the subject systems include, for example, absorption into a liquid or solid, adsorption, membrane transport and combinations thereof. The systems may be configured to provide for a gaseous CO₂ disposition that includes mineralization, geologic sequestration, biological sequestration, chemical conversion, electrochemical conversion and combinations thereof. In some cases, the gaseous CO₂ capture system additionally employs a gaseous CO₂ capture protocol that removes one or more additional pollutants from at least one gaseous CO₂ source of the plurality of gaseous CO₂ sources.

Aspects of the invention further include power plants. Power plants of interest include first and second CO₂ gas point source emitters, a common CO₂ capture system operatively coupled to each of the first and second CO₂ gas point source emitters, and a controller configured to control the first and second CO₂ gas point source emitters and common CO₂ capture system in a manner such that at least one gaseous CO₂ capture performance metric of the power plant is improved relative to a suitable control. In some cases, the first and second CO₂ gas point source emitters are flue-gas stacks, and the controller is configured to modulate flue gas rates or CO₂ concentrations in each of the flue-gas stacks. The common CO₂ capture system may, in embodiments, include a scrubber system (e.g., an amine scrubber system). In further embodiments, the common CO₂ capture system comprises a mineralization capture system. In such embodiments, the mineralization capture system may be configured to produce a solid carbonate material (e.g., a building material, such as an aggregate). Power plants of interest may be configured to increase the total amount of captured CO₂ relative to a suitable control.

Aspects of the invention additionally include industrial plants having a plurality of different types of CO₂ gas point source emitters, a common CO₂ capture system operatively coupled to each of the different types of CO₂ gas point source emitters, and a controller configured to control the different types of CO₂ gas point source emitters and common CO₂ capture system in a manner such that at least one gaseous CO₂ capture performance metric of the power plant is improved relative to a suitable control. In certain cases, the industrial plant is a refinery. CO₂ gas point source emitters of the industrial plants include, for example, coker units, fluidized catalytic crackers (FCCs), gas-fired furnaces, gas-fired boilers, and hydrogen-generating reformers. In certain cases, the industrial plant is a cement plant. In certain instances, the common CO₂ capture system comprises a scrubber system (e.g., an amine scrubber system). In further instances, the common CO₂ capture system comprises a mineralization capture system. In such embodiments, the mineralization capture system may be configured to produce a solid carbonate material (e.g., a building material, such as an aggregate). Industrial plants of interest may be configured to improve the efficiency with which CO₂ is captured.

Aspects of the invention also include gaseous CO₂ capture systems having a plurality of co-located industrial plants and/or power plants each comprising a gaseous CO₂ source operatively coupled to one or more mineralization capture sub-systems, a common mineralization capture system feed source, and a controller configured to control allocation of the feed source to the one or more mineralization capture sub-systems in a manner such that at least one gaseous CO₂ capture performance metric of the gaseous CO₂ capture system is improved relative to a suitable control. In certain cases, the feed source includes alkalinity (e.g., a solution containing aqueous ammonia). The co-located industrial plants described herein may be configured to improve the efficiency with which the feed source is used.

Some aspects of the invention additionally include a plurality of gaseous CO₂ sources each operatively coupled to a CO₂ capture sub-system, a common electrical grid operatively coupled to the plurality of gaseous CO₂ sources, and a controller configured to control power allocation to the plurality of gaseous CO₂ sources from the different types of power sources via the common electrical grid in a manner such that at least one gaseous CO₂ capture performance metric of the gaseous CO₂ capture system is improved relative to a suitable control. Common electrical grids of interest receive power from different types of power sources. Power sources in the subject systems may include, for example, renewable power sources, fossil fuel power sources, hydrogen power sources, and combinations thereof. In embodiments, the controller is configured to control power allocation based on one or more of: power cost, fraction of renewable power generation, power transportation cost, and combinations thereof. In certain embodiments, the CO₂ capture sub-system coupled to each gaseous CO₂ source is a mineralization capture system. The system may be configured to improve the efficiency with which power (e.g., renewable power) is used.

Certain aspects of the invention further include gaseous CO₂ capture systems having a first gaseous CO₂ source operatively coupled to a first CO₂ capture sub-system that produces a first mineralized feed building material from gaseous CO₂, a second gaseous CO₂ source operatively coupled to a second CO₂ capture sub-system that produces a second mineralized feed building material from gaseous CO₂, a common building material producer that prepares a building material from the first and second mineralized feed building materials, and, a controller configured to control production of the first and second mineralized feed building materials in a manner such that at least one gaseous CO₂ capture performance metric of the gaseous CO₂ capture system is improved relative to a suitable control. In certain cases, the first mineralized feed building material comprises an aggregate, the second mineralized feed building material comprises a cement, and the building material comprises a concrete. In embodiments, the systems are configured to optimize the ratio with which first and second mineralized feed building materials are used. For example, the ratio may be optimized according to the mix design of the concrete.

Methods for using and configuring the above systems are also provided. Methods of interest include configuring and/or operating a plurality of gaseous CO₂ sources and at least one common CO₂ capture constraining element shared by the plurality of CO₂ sources such that at least one gaseous CO₂ capture performance metric of the system is improved relative to a suitable control.

### BRIEF DESCRIPTION OF THE FIGURES

The invention may be best understood from the following detailed description when read in conjunction with the accompanying drawings. Included in the drawings are the following figures:

FIG. 1 depicts a power plant having first and second CO₂ gas point source emitters and a common CO₂ capture system according to certain embodiments.

FIG. 2 depicts a plurality of different types of CO₂ gas point source emitters and a common CO₂ capture system according to certain embodiments.

FIG. 3 depicts a plurality of co-located industrial plants and a common mineralization capture system feed source according to certain embodiments.

FIG. 4. depicts a plurality of gaseous CO₂ sources and a common electrical grid operatively coupled to the plurality of gaseous CO₂ sources according to certain embodiments.

FIG. 5 depicts first and second gaseous CO₂ sources and CO₂ capture sub-systems that produce first and second mineralized feed building materials from gaseous CO₂.

FIG. 6 presents a flowchart for practicing methods according to embodiments of the subject invention.

FIG. 7 depicts a known configuration of a plant that uses a conventional carbon capture and storage (CCS) system to produce pure CO₂ for liquefaction and subsurface storage.

FIG. 8 depicts a plant that uses a common CO₂ capture system to produce a bicarbonate rich aqueous solution, according to certain embodiments.

FIG. 9 depicts a common CO₂ mineralization system, e.g., a mineralization hub, according to certain embodiments.

### DETAILED DESCRIPTION

Gaseous CO₂ capture systems are provided. Systems of interest include a plurality of gaseous CO₂ sources and at least one common CO₂ capture constraining element shared by the plurality of CO₂ sources. The subject systems are configured to improve at least one gaseous CO₂ capture performance metric relative to a suitable control. Gaseous CO₂ capture systems involving power plants, industrial plants, common mineralization capture system feed sources, common electrical grids, and common building material producers are also provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Gaseous Co₂ Capture Systems

As discussed above, aspects of the invention include gaseous CO₂ capture systems. The subject systems include a plurality of gaseous CO₂ sources and at least one common CO₂ capture constraining element shared by the plurality of CO₂ sources. Systems of interest improve at least one gaseous CO₂ performance metric relative to a suitable control.

By “capturing CO₂” it is meant the removal or segregation (i.e., sequestration) of an amount of CO₂ from an environment, such as the Earth's atmosphere or a gaseous waste stream produced by an industrial plant, so that some or all of the CO₂ is no longer present in the environment from which it has been removed. In embodiments, the invention is configured to sequester CO₂ by producing a storage stable carbon dioxide sequestering product from an amount of CO₂, such that the CO₂ is sequestered. The storage stable CO₂ sequestering product is a storage stable composition that incorporates an amount of CO₂ into a storage stable form, such as an above-ground storage or underwater storage stable form, so that the CO₂ is no longer present as, or available to be, a gas in the atmosphere. In certain cases, the storage stable CO₂ sequestering product has an independent utility (e.g., as a building material).

By “common CO₂ capture constraining element”, it is meant a single element or collection of elements that is associated (e.g., shared in common) with each gaseous CO₂ source. In other words, while the gaseous CO₂ sources are physically distinct (e.g., located at a distance) relative to each other, the sources are linked via their shared association with the common CO₂ capture constraining element. Common CO₂ capture constraining elements are described in detail below and may include, for example, CO₂ capture liquid, proximity to a common location, access to a common transportation chain, mineralized product distribution center, power usage from a common grid, or a combination thereof.

As discussed herein, a “gaseous CO₂ performance metric” refers to a measure by which the efficacy and/or efficiency of CO₂ capture may be assessed. In some embodiments, the gaseous CO₂ performance metric is the amount of CO₂ captured by the system. For example, the system may, in certain cases, increase the amount of CO₂ captured by the system by 1% or more, 5% or more, 10% or more, 15% or more, 20% or more, 25% or more, 30% or more, 35% or more, 40% or more, 45% or more and including 50% or more. In other embodiments, the gaseous CO₂ capture performance metric is CO₂ capture efficiency. In some versions, CO₂ capture efficiency assesses the amount of one or more resources (e.g., energy, fuel, feed source) required to capture a given amount of CO₂. The subject systems may, where desired, increase CO₂ capture efficiency by 1% or more, 5% or more, 10% or more, 15% or more, 20% or more, 25% or more, 30% or more, 35% or more, 40% or more, 45% or more and including 50% or more. In still other embodiments, the gaseous CO₂ capture efficiency performance metric is the overall cost of CO₂ capture, which is the total cost associated with capturing all the CO₂. The subject systems may, where desired, decrease the cost of CO₂ capture by the system by 1% or more, 5% or more, 10% or more, 15% or more, 20% or more, 25% or more, 30% or more, 35% or more, 40% or more, 45% or more and including 50% or more. In still other embodiments, the gaseous CO₂ capture efficacy metric is a financial metric based on CO₂ capture such as a profit margin, a return on investment, a net present value or other. For example, these numbers may be improved by 1% or more, 5% or more, 10% or more, 15% or more, 20% or more, 25% or more, 30% or more, 35% or more, 40% or more, 45% or more and including 50% or more. In certain cases, the systems decrease the amount of energy required to capture a given amount of carbon. In additional embodiments, CO₂ capture efficiency includes feed source utility efficiency. In such embodiments, the subject systems increase the efficiency with which a feed source (e.g., the source of a solution configured for the capture and/or mineralization of CO₂) is employed. In still other embodiments, the gaseous CO₂ capture performance metric includes power usage efficiency. In certain cases, power usage efficiency is determined by one or more of power cost, fraction of renewable power generation, power transportation cost, and combinations thereof. In yet other embodiments, gaseous CO₂ capture performance metric comprises usage efficiency of the captured CO₂ (e.g., as mineralized feed building materials). In select versions, the gaseous CO₂ performance metric is parasitic load, defined as a percentage of the energy consumed by the system used to power ancillary devices that are not directly related to CO₂ capture, transportation, and/or mineralization. The subject systems may, where desired, decrease the parasitic load relative to a suitable control by 1% or more, 5% or more, 10% or more, 15% or more, 20% or more, 25% or more, 30% or more, 35% or more, 40% or more, 45% or more and including 50% or more. In some cases, systems of the invention are characterized as having a parasitic load of 4% or less, such as 3% or less, such as 2% or less, such as 1% or less, such as 0.5% or less, such as 0.1% or less and including 0.05% or less.

The aforementioned CO₂ capture performance metric is improved relative to a suitable control. The “suitable control” discussed herein refers to a gaseous CO₂ capture system that does not include a common CO₂ capture constraining element. In other words, the control includes a plurality of gaseous CO₂ sources and each source includes a dedicated mechanism for capturing the emitted CO₂ that is not associated in any relevant manner with the other gaseous CO₂ sources. In some embodiments, the suitable control includes the same number and/or type of gaseous CO₂ sources as one or more embodiments of the present systems. In additional instances, the suitable control includes the same carbon capture mechanism(s) as the present systems. The suitable control described herein may or may not be a system that physically exists. For example, in certain cases, the suitable control is a mathematical model simulating the operation of hypothetical gaseous CO₂ sources and the carbon sequestration therefrom. In other cases, the suitable control is an existing system.

### Gaseous CO₂ Sources

The CO₂ containing gas that is processed by the present systems is one that includes CO₂. The CO₂ containing gas may be pure CO₂ or be combined with one or more other gasses and/or particulate components, depending upon the source, e.g., it may be a multi-component gas (i.e., a multi-component gaseous stream). While the amount of CO₂ in such gasses may vary, in some instances the CO₂ containing gasses have a pCO₂ of 10³ Pa or higher, such as 10⁴ Pa or higher, such as 10⁵ Pa or higher, including 10⁶ Pa or higher. The amount of CO₂ in the CO₂ containing gas, in some instances, may be 20,000 ppm or greater, e.g., 50,000 ppm or greater, such as 100,000 ppm or greater, including 150,000 ppm or greater, e.g., 500,000 ppm or greater, 750,000 ppm or greater, 900,000 ppm or greater, up to including 1,000,000 ppm (In pure CO₂ exhaust the concentration is 1,000,000 ppm) In some instances may range from 10,000 to 500,000 ppm, such as 50,000 to 250,000 ppm, including 100,000 to 150,000 ppm. The temperature of the CO₂ containing gas may also vary, ranging in some instances from 0 to 1800° C., such as 100 to 1200° C. and including 600 to 700° C.

As indicated above, in some instances the CO₂ containing gasses are not pure CO₂, in that they contain one or more additional gasses and/or trace elements. Additional gasses that may be present in the CO₂ containing gas include, but are not limited to water, nitrogen, mononitrogen oxides, e.g., NO, NO₂, and NO₃, oxygen, sulfur, monosulfur oxides, e.g., SO, SO₂ and SO₃), volatile organic compounds, e.g., benzo(a)pyrene C₂OH₁₂, benzo(g,h,l)perylene C₂₂H₁₂, dibenzo(a,h)anthracene C₂₂H₁₄, etc. Particulate components that may be present in the CO₂ containing gas include, but are not limited to particles of solids or liquids suspended in the gas, e.g., heavy metals such as strontium, barium, mercury, thallium, etc.

Any convenient CO₂ emitting source may be employed as a gaseous CO₂ source described herein. In some embodiments, one or more gaseous CO₂ sources in the plurality of gaseous CO₂ sources is a CO₂ gas point source emitter. As discussed herein, the term “CO₂ gas point source emitter” is employed in its conventional sense to describe a single identifiable source of gaseous CO₂ emissions (i.e., as opposed to CO₂ present in the atmosphere, more generally). In certain embodiments, CO₂ containing gasses are obtained from an industrial plant, e.g., where the CO₂ containing gas is a waste from an industrial plant. Industrial plants from which the CO₂ containing gas may be obtained, e.g., as a waste from the industrial plant, may vary. Industrial plants of interest include, but are not limited to, power plants and industrial product manufacturing plants, such as but not limited to chemical and mechanical processing plants, refineries, cement plants, smelters, steel plants, etc., as well as other industrial plants that produce CO₂ as a byproduct of fuel combustion or other processing step (such as calcination by a cement plant or reformation in a hydrogen plant). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, and their derivatives as well as man-made fuel products of naturally occurring organic fuel deposits, such as but not limited to tar sands, heavy oil, oil shale, etc., and their derivatives. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Each of these types of industrial plants may burn a single fuel, or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant.

In other embodiments, the one or more gaseous CO₂ sources in the plurality of gaseous CO₂ sources is a CO₂ gas direct air capture (DAC) source. DAC systems are a class of technologies capable of separating carbon dioxide CO₂ directly from ambient air. A DAC system is any system that captures CO₂ directly from air and generates a product gas that includes CO₂ at a higher concentration than that of the air that is input into the DAC system. While the concentration of CO₂ in the DAC generated gaseous source of CO₂ may vary, in some instances the concentration is 1,000 ppm or greater, such as 10,000 ppm or greater, including 100,000 ppm or greater, where the product gas may not be pure CO₂, such that in some instances the product gas is 3% or more non-CO₂ constituents, such as 5% or more non-CO₂ constituents, including 10% or more non-CO₂ constituents. Non-CO₂ constituents that may be present in the product stream may be constituents that originate in the input air and/or from the DAC system.

DAC systems are systems that extract CO₂ from the air using media that binds to CO₂ but not to (or minimally to) other atmospheric chemicals (such as nitrogen and oxygen). As air passes over the CO₂ binding medium, CO₂ “sticks” to the binding medium. In response to a stimulus, e.g., heat, humidity, etc., the bound CO₂ may then be released from the binding medium resulting the production of a gaseous CO₂ containing product. DAC systems of interest include, but are not limited to: hydroxide based systems; CO₂ sorbent/temperature swing based systems, and CO₂ sorbent/temperature swing based systems. In some instances, the DAC system is a hydroxide based system, in which CO₂ is separated from air by contacting the air with is an aqueous hydroxide liquid. Examples of hydroxide based DAC systems include, but are not limited to, those described in PCT published application Nos. WO/2009/155539; WO/2010/022339; WO/2013/036859; and WO/2013/120024; the disclosures of which are herein incorporated by reference.

In some instances, the DAC system is a CO₂ sorbent based system, in which CO₂ is separated from air by contacting the air with sorbent, such as an amine sorbent, followed by release of the sorbent captured CO₂ by subjecting the sorbent to one or more stimuli, e.g., change in temperature, change in humidity, etc. Examples of such DAC systems include, but are not limited to, those described in PCT published application Nos. WO/2005/108297; WO/2006/009600; WO/2006/023743; WO/2006/036396; WO/2006/084008; WO/2007/016271; WO/2007/114991; WO/2008/042919; WO/2008/061210; WO/2008/131132; WO/2008/144708; WO/2009/061836; WO/2009/067625; WO/2009/105566; WO/2009/149292; WO/2010/019600; WO/2010/022399; WO/2010/107942; WO/2011/011740; WO/2011/137398; WO/2012/106703; WO/2013/028688; WO/2013/075981; WO/2013/166432; WO/2014/170184; WO/2015/103401; WO/2015/185434; WO/2016/005226; WO/2016/037668; WO/2016/162022; WO/2016/164563; WO/2016/161998; WO/2017/184652; and WO/2017/009241; the disclosures of which are herein incorporated by reference.

Systems of interest may include any convenient number of gaseous CO₂ sources. For example, in some cases, the number of gaseous CO₂ sources ranges from 2 to 50, such as 2 to 25, such as 2 to 10 and including 2 to 5. The types of gaseous CO₂ sources employed in the subject systems may be the same or different. In one example where the system includes two gaseous CO₂ sources, both the first and second gaseous CO₂ sources are point source emitters (e.g., power plants, cement plants, smelters, refineries and chemical plants, or a combination thereof). In another example, both the first and second gaseous CO₂ sources are DAC sources. In yet another example, the first gaseous CO₂ source is a point source, and the second gaseous CO₂ source is a DAC source.

### Common CO₂ Capture Constraining Element

As discussed above, the subject gaseous CO₂ capture system includes a common CO₂ capture constraining element. In some instances, the common CO₂ capture constraining element is a CO₂ capture liquid. By “CO₂ capture liquid”, it is meant an organic or aqueous medium that may be contacted with a CO₂-containing gas, thereby removing the CO₂ from the CO₂-containing gas (e.g., as described in greater detail below). Where the common CO₂ capture constraining element is CO₂ capture liquid, the present systems are arranged in such a way the same CO₂ capture liquid is circulated throughout two or more—and, in some embodiments, all—of the gaseous CO₂ sources so that gaseous CO₂ is received by the capture liquid from each gaseous CO₂ source. In certain cases where the common CO₂ capture constraining element is the capture liquid, a gaseous CO₂ capture performance metric (e.g., such as those described above) may be increased via sharing the capture liquid as well as the structures for maintaining (e.g., generating, storing, circulating, regenerating, etc.) the capture liquid among the different gaseous CO₂ sources. In other cases where the common CO₂ capture constraining element is the capture liquid, a gaseous CO₂ capture performance metric (e.g., such as those described above) may be increased via sharing the regeneration requirements of the capture liquid among the different gaseous CO₂ sources.

The CO₂ containing gas from each gaseous CO₂ source may be contacted with the liquid medium using any convenient protocol. For example, contact protocols of interest include, but are not limited to direct contacting protocols, e.g., bubbling the gas through a volume of the liquid medium, concurrent contacting protocols, i.e., contact between unidirectionally flowing gaseous and liquid phase streams, countercurrent protocols, i.e., contact between oppositely flowing gaseous and liquid phase streams, and the like. Contact may be accomplished through use of infusers, bubblers, fluidic Venturi reactors, spargers, gas filters, sprays, trays, or packed column reactors, and the like, as may be convenient.

In certain cases where the common CO₂ capture constraining element is the capture liquid, said capture liquid may be circulated through the different gaseous CO₂ sources in a particular order. Any convenient criteria may determine the order of gaseous CO₂ sources among which the capture liquid is circulated. In some embodiments, the order is determined by proximity of the gaseous CO₂ sources relative to one another. In one example, after the capture liquid receives CO₂ from a first gaseous CO₂ source, the capture liquid is transported (e.g., via one or more pipes) to a second gaseous CO₂ that is located in close geographical proximity to the first gaseous CO₂ source (i.e., instead of a third gaseous CO₂ source that is located at a farther distance).

In other embodiments, the order in which the capture liquid is circulated through the different gaseous CO₂ sources is determined by the partial pressure of gaseous CO₂ being emitted in each gaseous CO₂ source. The capture liquid may, in such embodiments, be transported from a gaseous CO₂ source having a low partial pressure of CO₂ to a gaseous CO₂ source having a comparatively higher partial pressure of CO₂. In one example where there are three different gaseous CO₂ sources, the capture liquid receives CO₂ from the gaseous CO₂ source having the lowest partial pressure of CO₂, is transported to the gaseous CO₂ source having the second lowest partial pressure of CO₂, and is subsequently transported to the gaseous CO₂ source having the highest partial pressure of CO₂. In certain cases, the partial pressure of the gaseous CO₂ sources fluctuates, and the system is configured to shift the circulation of capture liquid such that the liquid is transported from the gaseous CO₂ source having a low partial pressure of CO₂ to a gaseous CO₂ source having a comparatively higher partial pressure of CO₂, whichever gaseous CO₂ sources those may be.

The temperature of the liquid medium that is contacted with the gas may vary. In some instances, the temperature ranges from −1.4 to 100° C., such as 20 to 80° C. and including 40 to 70° C. In some instances, the temperature may range from −1.4 to 50° C. or higher, such as from −1.1 to 45° C. or higher. In some instances, cool water temperatures are employed, where such temperatures may range from −1.4 to 4° C., such as −1.1 to 0° C. While an initial aqueous media may be cooled to obtain the desired temperature, in some instances a natural source of the aqueous media having the desired optimal temperature may be employed. For example, where the aqueous medium is ocean or seawater, the ocean or sea water may be obtained from a location where the water has the desired temperature. In some instances, obtaining such water may include obtaining the water from a depth below the surface of the water (e.g., the surface of the ocean), where the depth may range in some instances from 10 to 2000 meters, such as 20 to 200 m.

In some instances, warmer temperatures are employed. For example, the temperature of the liquid medium in some instances may be 25° C. or higher, such as 30° C. or higher, and may in some embodiments range from 25 to 50° C., such as 30 to 40° C. While a given liquid medium may be warmed in such instances to arrive at these temperatures, in some instances the liquid medium may be obtained from a naturally occurring source which is at the desired warm temperature, or obtained from a man-made source that provides the desired temperature, e.g., from the output of an industrial, e.g., power, plant cooling system, etc.

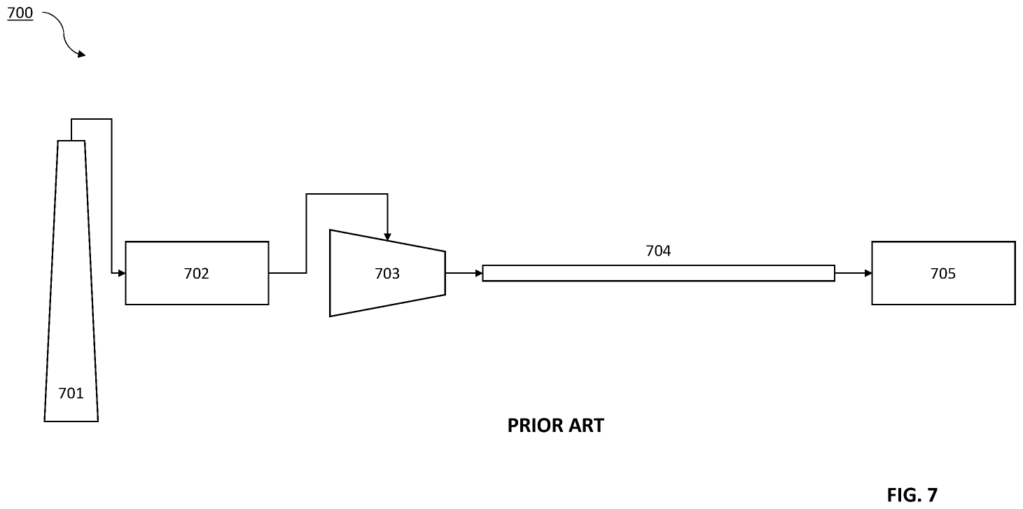

In some embodiments, after CO₂ is captured by the capture liquid, the capture liquid may be referred to as a bicarbonate rich aqueous solution. The mechanism by which bicarbonate is produced is described in greater detail below. In some such embodiments, the capture liquid is not cooled and/or compressed to produce a liquefied CO₂ stream. As discussed in the Introduction section with respect to FIG. 7, captured CO₂ is often conventionally transported in the form of a liquefied CO₂ stream. However, the present inventors have realized that certain procedural efficiencies may be achieved by transporting CO₂ in the form of a bicarbonate rich aqueous solution as compared to a liquefied CO₂ stream. These efficiencies are demonstrated and described in further detail below in the Experimental section. Systems according to select embodiments of the invention may be configured such that the bicarbonate rich aqueous solution obtained from and/or circulated through each gaseous CO₂ source is provided to a common location for treatment (i.e., mineralization and/or regeneration, as described in detail herein). In some embodiments, the capture liquid is regenerated at the common location (e.g., such that an aqueous ammonia capture liquid is formed) and recirculated to each of the gaseous CO₂ sources.

In some versions, the common CO₂ capture constraining element includes proximity to a common location. The “common location” referred to herein includes any site having one or more resources that may be shared in common by a plurality of gaseous CO₂ capture sub-systems that are associated with a plurality of gaseous CO₂ sources, or a site at which the CO₂ capture sub-systems may pool outputs (e.g., cement, aggregate). The common location may, in certain cases, be a transportation hub. In such cases, the common location is a point (i.e., hub) within a transportation network at which materials may be received and/or shipped out. Transportation hubs include, but are not limited to, seaports, train/rail stations, airports, warehouses, pipelines, and the like.

The term “gaseous CO₂ capture sub-systems” refers to a series of gaseous CO₂ capture systems that operate independently from one another, but share certain resources (e.g., a source of alkalinity) or pool certain outputs. In some instances, the resources shared by the gaseous CO₂ capture sub-systems include a common mineralization capture system feed source. Common mineralization capture system feed sources of interest include, for example, aqueous media sources, ammonia sources, as well as alkalinity sources (e.g., as described in detail below). In some embodiments, each gaseous CO₂ capture sub-system in the plurality of gaseous CO₂ capture sub-systems is associated with an individual gaseous CO₂ source (e.g., power plant, cement plant, smelter, refinery, chemical plant) and is configured to sequester CO₂ from that source. In some embodiments, the common location includes a stored resource (e.g., a source of alkalinity, aqueous medium, ammonia, amine, etc.) that may be drawn upon as needed at the gaseous CO₂ capture sub-systems. In certain cases, the gaseous CO₂ capture sub-systems are mineralization capture sub-systems; in such embodiments, the gaseous CO₂ capture sub-systems include co-located components for producing mineralized material (e.g., mineralized building materials), as discussed in greater detail below.

Each gaseous CO₂ source in the plurality of gaseous CO₂ sources, as well as the associated CO₂ capture sub-systems, may be located at any convenient distance from the common location. For example, in some embodiments, the gaseous CO₂ sources may be separated from the common location by a distance ranging from 0.01 km to 500 km, such as 0.2 km to 400 km, such as 0.5 km to 300 km, such as 1 km to 250 km, such as 1.5 km to 200 km, such as 2 km to 150 km, such as 2.5 km to 100 km, such as 3 km to 50 km, and including 4 km to 25 km. The resource present at the common location may be transported to the gaseous CO₂ sources and CO₂ capture sub-systems via any suitable protocol. In certain aspects of the invention, the resource is transported via roadways (e.g., via truck). In other instances, the resource is transported via train/rail. In still other embodiments, the resource is transported via water, e.g., on a transport ship or a barge. It yet other embodiments, such as where the sequestered carbon is in the form of a liquid (e.g., a carbonate slurry or bicarbonate slurry), the resource is transported via a pipeline. Where systems include access to a common location, materials may be transported to each CO₂ capture sub-system from the common transportation chain, from each CO₂ capture sub-system to the common location, or both.

In some embodiments, the common CO₂ capture constraining element includes access to a common transportation chain. By “common transportation chain” it is meant a transportation chain along which each gaseous CO₂ source and associated CO₂ capture sub-system is positioned. In other words, instead of each gaseous CO₂ source and associated CO₂ capture sub-system being associated with a common location (e.g., transportation hub), each gaseous CO₂ source and associated CO₂ capture sub-system is, itself, positioned along the same transportation chain. Transportation chains of interest include, but are not limited to, train/rail lines, trucking routes, air routes, sea routes, pipelines, and combinations thereof.

Where systems include access to a common transportation chain, materials may be transported to each CO₂ capture sub-system via the common transportation chain, from each CO₂ capture sub-system via the common transportation chain, or both. For example, in some embodiments, resources from a common mineralization capture system feed source (e.g., such as those described above) are supplied to each of the CO₂ capture sub-systems via the common transportation chain. In additional embodiments, sequestered carbon is transported along the common transportation chain from each CO₂ capture sub-system to one or more locations, as desired. In some embodiments, the gaseous CO₂ sources and associated CO₂ capture sub-system may be separated a location on the common transportation chain by a distance ranging from 0.01 km to 500 km, such as 0.1 km to 400 km, such as 0.5 km to 300 km, such as 1 km to 250 km, such as 1.5 km to 200 km, such as 2 km to 150 km, such as 2.5 km to 100 km, such as 3 km to 50 km, and including 4 km to 25 km.

Sequestered carbon transported in the subject systems may have any convenient form. For example, in some embodiments, the sequestered carbon is a bicarbonate rich product (BRP). In some embodiments, the bicarbonate rich product is a constituent in an aqueous solution. By bicarbonate rich product is meant a composition characterized by high concentrations of bicarbonate ion, where the concentration of bicarbonate ion may, in some instances, be 5,000 ppm or greater, such as 10,000 ppm or greater, including 15,000 ppm or greater. In some instances, the bicarbonate ion in the bicarbonate rich products ranges from 5,000 to 20,000 ppm, such as 7,500 to 15,000 ppm, including 8,000 to 12,000 ppm. In some instances, the overall amount of bicarbonate ion may range from 0.1 wt. % to 30 wt. %, such as 3 to 20 wt. %, including from 10 to 15 wt. %. The pH of the bicarbonate rich product produced upon combination of the CO₂ source and aqueous medium, e.g., as described above, may vary, and in some instances range from 4 to 10, such as 6 to 9 and including 8 to 8.5.

The bicarbonate rich product may be a liquid composition that includes a single phase or two or more different phases. In some embodiments, the bicarbonate rich product includes droplets of a liquid condensed phase (LCP) in a bulk liquid, e.g., bulk solution. By “liquid condensed phase” or “LCP” is meant a phase of a liquid solution which includes bicarbonate ions wherein the concentration of bicarbonate ions is higher in the LCP phase than in the surrounding, bulk liquid. LCP droplets are characterized by the presence of a meta-stable bicarbonate-rich liquid precursor phase in which bicarbonate ions associate into condensed concentrations exceeding that of the bulk solution and are present in a non-crystalline solution state.

In additional embodiments, the sequestered CO₂ transported in the subject systems includes an aggregate (e.g., discussed in greater detail below). As the aggregate is a carbonate aggregate, the particles of the granular material include one or more carbonate compounds, where the carbonate compound(s) component may be combined with other substances (e.g., substrates) or make up the entire particles, as desired. In yet other embodiments, the sequestered carbon transported in the subject systems includes cements or bicarbonate additives for cements. Cements may be transported in liquid or solid forms, as desired. In certain cases, the sequestered carbon transported in the subject systems includes settable compositions of the invention, such as concretes and mortars. Settable cementitious compositions of the invention are prepared from combination of a cement, a setting liquid and a BRP additive/admixture (e.g., as described above), where the compositions may further include one or more additional components, such as but not limited to: aggregates, chemical admixtures, mineral admixtures, etc.

In other embodiments, the sequestered CO₂ transported in the subject systems includes chemical compounds in the solid state, for example, chemical compounds in the solid state such as but not limited to sodium bicarbonate (NaHCO₃), commonly known as baking soda; sodium carbonate (Na₂CO₃), commonly known as soda ash; ammonium bicarbonate (NH₄HCO₃), commonly used as a leavening agent in the food industry; precipitated calcium carbonate (PCC), commonly used in a variety of applications as an additive in sealants, adhesives, plastics, rubber, inks, paper, pharmaceuticals, nutritional supplements and many other demanding applications; and the like.

In further embodiments, the sequestered carbon transported in the subject systems includes a substantially pure CO₂ product (for example, compressed CO₂, liquified CO₂ or supercritical CO₂). The substantially pure CO₂ product gas may be stored in, for example, pressurized pipelines. In some embodiments, the CO₂ product gas from multiple gaseous CO₂ sources and associated gaseous CO₂ capture sub-systems may be transported to a common location at which the gas is disposed of (e.g., by injecting the product CO₂ gas into a subsurface geological location, as discussed below). In other instances, the product CO₂ gas may be sold and/or employed as needed in one or more other industrial processes, as desired.

In certain cases, the common CO₂ capture constraining element is a mineralized product distribution center. By “mineralized product distribution center”, it is meant a location from which CO₂ embodied in a solid form (e.g., a CO₂ embodied cement, a CO₂ embodied aggregate) may be distributed. For example, in some instances, the mineralized product distribution center is a retail location from which the mineralized product is sold (e.g., to a construction company or a contractor). In other embodiments, the mineralized product distribution center is a storage location where mineralized product is warehoused until a time it is requisitioned for use.

In still other embodiments, the common CO₂ capture constraining element is power usage from a common grid. In such embodiments, the gaseous CO₂ point sources and/or the CO₂ capture sub-systems are connected to a common power grid such that those components share the same source or sources of energy for operation. In other words, gaseous CO₂ sources and associated CO₂ capture sub-system connected to a common power grid do not have individual (i.e., exclusive) power generating mechanisms.

Any suitable power source may supply power to the common power grid. In some aspects, the disclosed systems include one or more power plants. As used herein, the terms “power plant” and “power station”, refer to a facility for the generation of electric power. In particular aspects, power plants house components for generating and transmitting electric power. Any convenient number of power plants may contribute electricity to the common power grid. For example, the number of power plants may range from 2 to 10, such as 2 to 5, and including 2 to 3.

Power plants, in some embodiments, generate electrical power from fossil fuels (e.g., coal, oil, and/or natural gas), nuclear power or renewable energy sources. In some aspects, power plants provide electric power to consumers of electric power outside the power plant. In some versions, power plants generate electrical power from hydrogen. The hydrogen employed in the power plants may, in some instances, include blue hydrogen (i.e., hydrogen derived from methane in natural gas whereby the CO₂ emissions are typically managed through market offset or technical abatement, e.g., a gaseous CO₂ capture system). In other instances, the hydrogen employed in the power place is green hydrogen (i.e., hydrogen derived by splitting water into hydrogen and oxygen). Where the hydrogen is blue hydrogen, some embodiments of the systems may additionally include a steam reformer. The steam reformer described herein is configured to produce hydrogen and carbon monoxide by reacting hydrocarbons (e.g., methane) with water. In additional embodiments, systems include an autothermal reformer. The autothermal reformer described herein reacts oxygen and carbon dioxide or steam with methane to form hydrogen and carbon monoxide. Where the hydrogen is blue hydrogen, other embodiments of the systems may additionally include a partial oxidation reactor. The partial oxidation reactor described herein is configured to produce hydrogen and carbon monoxide by reacting hydrocarbons (e.g., methane) with oxygen.

In some embodiments, power plants include electrical components. For example, power plants may include temperature and/or lighting control systems as well as electrical components for electrically connecting consumers of electrical power to the power plant. In some instances, power plants (e.g., power plants operating independently) use an amount of energy (e.g., electrical energy) for each amount of electrical power produced. In certain cases where power plants create gaseous CO₂ emissions, power plants may, themselves, include a CO₂ capture sub-system that is a component of the subject gaseous CO₂ capture system.

Where the common CO₂ capture constraining element is power usage from a common grid, some embodiments of the system include a controller configured to control power allocation to the plurality of gaseous CO₂ sources from the different types of power sources via the common electrical grid in a manner such that at least one gaseous CO₂ capture performance metric of the gaseous CO₂ capture system (e.g., such as those described above) is improved relative to a suitable control. In some embodiments, the controller is configured to control power allocation based on power cost. As certain forms of energy may be more expensive than other forms of energy, some versions of the controller may preferentially allocate power from one or more power sources that are less expensive to the gaseous CO₂ sources. In additional embodiments, the controller is configured to control power allocation based on the fraction of renewable power generation. Where power sources in the plurality of power sources vary with respect to renewability (i.e., being derived from natural processes that are replenished), the controller may be configured to preferentially allocate power from one or more power sources that are more renewable to the gaseous CO₂ sources.

In some embodiments, the gaseous CO₂ capture system includes a common building material producer. In such embodiments, the common building material producer is configured to receive at least first and second mineralized feed building materials from the CO₂ capture sub-systems associated with a plurality of gaseous CO₂ sources. In other words, the outputs of each CO₂ capture sub-system are pooled at the common building material producer. The number of gaseous CO₂ sources and CO₂ capture sub-systems may vary. In some embodiments, the number of gaseous CO₂ sources and CO₂ capture sub-systems ranges from 2 to 10, such as 2 to 5, and including 2 to 3. In certain cases, the gaseous CO₂ capture system includes 2 (i.e., a first and second) gaseous CO₂ sources and CO₂ capture sub-systems. In such embodiments, the first CO₂ gaseous source is operatively coupled to a first CO₂ capture sub-system that produces a first mineralized feed building material (e.g., cement) from gaseous CO₂, and the second CO₂ gaseous source is operatively coupled to a second CO₂ capture sub-system that produces a second mineralized feed building material (e.g., aggregate) from gaseous CO₂. In some cases, the common building material producer prepares a building material (e.g., concrete) from the first and second mineralized feed building materials.

In certain cases, involving a common building material producer, systems include a controller configured to control production of the first and second mineralized feed building materials in a manner such that at least one gaseous CO₂ capture performance metric of the gaseous CO₂ capture system is improved relative to a suitable control. In some instances, the controller is configured to optimize the fraction of gaseous CO₂ capture conducted in each of the first and second gaseous CO₂ capture subsystems to align with the needs of the common building material producer.

### Gaseous CO₂ Capture Protocols

As discussed above, the gaseous CO₂ capture system employs a gaseous CO₂ capture protocol. Any suitable gaseous CO₂ capture protocol may be employed. In some instances, the CO₂ capture protocol includes absorption into a liquid (e.g., a capture liquid, as discussed in greater detail below). In still other embodiments, the gaseous CO₂ capture protocol includes adsorption (e.g., a solid adsorbent, as discussed below). In still other embodiments, the CO₂ capture protocol includes membrane transport. In yet other embodiments, the gaseous CO₂ capture system employs a combination of gaseous CO₂ capture protocols, e.g., any combination of absorption into a liquid or solid, adsorption, membrane transport, and the like.

In some embodiments, wherein the gaseous CO₂ capture protocol includes the use of solid adsorbents, e.g., zeolites, molecular sieves, polymers, carbon, alumina, silica, polyoxometalates (POMs), metal organic frameworks (MOFs), and the like, the CO₂ in the plurality of gaseous CO₂ sources is adsorbed on the surface of the solid adsorbent to accomplish a separation of the CO₂ from the plurality of gaseous CO₂ sources. In some instances, the solid adsorbents are activated prior to use in the gaseous CO₂ capture protocol. In other instances, the solid adsorbents are a constituent of a pressure swing adsorption or a temperature swing adsorption method to separate CO₂. In certain cases, the adsorbed CO₂ is then released from the solid adsorbent to yield a substantially pure CO₂ product gas to be transported by the subject systems described above. Examples of gaseous CO₂ capture protocols that use solid adsorbents include, but are not limited to, those described in PCT published application Nos. WO/2011/013332; WO/2009/105255; WO/2014/100904; WO/2014/28038; and U.S. Pat. Nos. 9,283,512; 9,012,355; 8,591,627; the disclosures of which are incorporated herein in their entirety.

In certain cases where the gaseous CO₂ capture protocol includes absorption into a liquid, gaseous CO₂ capture systems of interest include a CO₂ capture liquid. The capture liquid may vary. Examples of capture liquids include, but are not limited to, fresh water and bicarbonate buffered aqueous media. Bicarbonate buffered aqueous media employed in embodiments of the invention include liquid media in which a bicarbonate buffer is present. The bicarbonate buffered aqueous medium may be a naturally occurring or man-made medium, as desired. Further details regarding such capture liquids are provided in PCT published application Nos. WO/2014/039578; WO 2015/134408; and WO 2016/057709; the disclosures of which applications are herein incorporated by reference. CO₂ capture systems involving the use of a CO₂ capture liquid are described in, for example, U.S. Pat. Nos. 9,707,513; 9,714,406; 9,993,799; 10,711,236; 10,766,015; and 10,898,854; the disclosures of which are incorporated herein in their entirety.

Systems of the invention may have any configuration that enables practice of the particular sequestration material production method of interest. In embodiments, systems of the invention include one or more reactors that are configured for producing CO₂ sequestering carbonate materials. In some embodiments, the systems include continuous reactors (i.e., flow reactors), e.g., reactors in which materials are carried in a flowing stream, where reactants (e.g., divalent cations, aqueous bicarbonate rich liquid, aqueous capture ammonia etc.) are continuously fed into the reactor and emerge as continuous stream of product. A given system may include the continuous reactors, e.g., as described herein, in combination with one or more additional elements, as described in greater detail below. In other embodiments, the subject systems include batch reactors.

The aqueous medium source and the gaseous CO₂ source are connected to a reactor configured to contact the CO₂ containing gas with the capture liquid. The reactor may include any of a number of components, such as temperature regulators (e.g., configured to heat the water to a desired temperature), chemical additive components, e.g., for introducing agents that enhance bicarbonate production, mechanical agitation and physical stirring mechanisms. The reactor may include a catalyst that mediates the conversion of CO₂ to bicarbonate. The reactor may also include components that allow for the monitoring of one or more parameters such as internal reactor pressure, pH, metal-ion concentration, and pCO₂.

While the aqueous medium may vary depending on the particular protocol being performed, aqueous media of interest include pure water as well as water that includes one or more solutes, e.g., divalent cations, such as Mg²⁺, Ca²⁺, counterions, e.g., carbonate, hydroxide, etc., where in some instances the aqueous medium may be a bicarbonate buffered aqueous medium. Bicarbonate buffered aqueous media employed in methods of the invention include liquid media in which a bicarbonate buffer is present. As such, liquid aqueous media of interest include dissolved CO₂, water, carbonic acid (H₂CO₃), bicarbonate ions (HCO₃⁻), protons (H⁺) and carbonate ions (CO₃²⁻). The constituents of the bicarbonate buffer in the aqueous media are governed by the equation:

CO₂+H₂O [symbol] H₂CO₃ [symbol] H⁺HCO₃⁻ [symbol] 2H⁺+CO₃²⁻

In aqueous media of interest, the amounts of the different carbonate species components in the media may vary according to the pH. In some instances, below around or about pH 4.5, the amount of carbonic acid ranges from 50 to 100%, such as 70 to 90%, the amount of bicarbonate ion around or about pH 4-9 ranges from 10 to 95%, such as 20 to 90% and the amount of carbonate ion above around or about pH 9 ranges from 10 to 100%, such as 10 to 70%. The pH of the aqueous media may vary, ranging in some instances from 7 to 11, such as 8 to 11, e.g., 8 to 10, e.g., 8 to 9.5, such as 8 to 9.3, including 8 to 9. In some instances, the pH ranges from 8.2 to 8.7, such as from 8.4 to 8.55.

The bicarbonate buffered aqueous medium may be a naturally occurring or man-made medium, as desired. Naturally occurring bicarbonate buffered aqueous media include, but are not limited to, waters obtained from seas, oceans, lakes, swamps, estuaries, lagoons, brines, alkaline lakes, inland seas, etc. Man-made sources of bicarbonate buffered aqueous media may also vary, and may include brines produced by water desalination plants, and the like. Of interest in some instances are waters that provide for excess alkalinity, which is defined as alkalinity which is provided by sources other than bicarbonate ion. In these instances, the amount of excess alkalinity may vary, so long as it is sufficient to provide 1.0 or slightly less, e.g., 0.9, equivalents of alkalinity. Waters of interest include those that provide excess alkalinity (meq/liter) of 30 or higher, such as 40 or higher, 50 or higher, 60 or higher, 70 or higher, 80 or higher, 90 or higher, 100 or higher, etc. Where such waters are employed, no other source of alkalinity, e.g., NaOH, is required.

In embodiments, systems further include a divalent cation introducer configured to introduce divalent cations at an introduction location into the flowing aqueous liquid. Any convenient introducer may be employed, where the introducer may be a liquid phase or solid phase introducer, depending on the nature of the divalent cation source. The introducer may be located in some instances at substantially the same, if not the same, position as the inlet for the bicarbonate rich product containing liquid. Alternatively, the introducer may be located at a distance downstream from the inlet. In such instances, the distance between the inlet and the introducer may vary, ranging in some embodiments from 1 cm to 10 m, such as 10 cm to 1 m. The introducer may be operatively coupled to a source or reservoir of divalent cations.

Inclusion of divalent cations in the aqueous media can allow the concentration of bicarbonate ion in the bicarbonate rich product to be increased, thereby allowing a much larger amount of CO₂ to become sequestered as bicarbonate ion in the bicarbonate rich product. In such instances, bicarbonate ion concentrations that exceed 5,000 ppm or greater, such as 10,000 ppm or greater, including 15,000 ppm or greater may be achieved. For instance, calcium and magnesium occur in seawater at concentrations of 400 and 1200 ppm respectively. Through the formation of a bicarbonate rich product using seawater (or an analogous water as the aqueous medium), bicarbonate ion concentrations that exceed 10,000 ppm or greater may be achieved.

In such embodiments, the total amount of divalent cation source in the medium, which divalent cation source may be made up of a single divalent cation species (such as Ca²⁺) or two or more distinct divalent cation species (e.g., Ca²⁺, Mg²⁺, etc.), may vary, and in some instances is 100 ppm or greater, such as 200 ppm or greater, including 300 ppm or greater, such as 500 ppm or greater, including 750 ppm or greater, such as 1,000 ppm or greater, e.g., 1,500 ppm or greater, including 2,000 ppm or greater. Divalent cations of interest that may be employed, either alone or in combination, as the divalent cation source include, but are not limited to: Ca²⁺, Mg²⁺, Be²⁺, Ba²⁺, Sr²⁺, Pb²⁺, Fe²⁺, Hg²⁺, and the like. Other cations of interest that may or may not be divalent include, but are not limited to: Na⁺, K⁺, NH⁴⁺, and Li⁺, as well as cationic species of Mn, Ni, Cu, Zn, Fe, Ce, La, Al, Y, Nd, Zr, Gd, Dy, Ti, Th, U, La, Sm, Pr, Co, Cr, Te, Bi, Ge, Ta, As, Nb, W, Mo, V, etc. Naturally occurring aqueous media which include a cation source, divalent or otherwise, and therefore may be employed in such embodiments include, but are not limited to: aqueous media obtained from seas, oceans, estuaries, lagoons, brines, alkaline lakes, inland seas, etc.

In some instances, the systems include a second reactor configured to further process the bicarbonate rich product, e.g., to dry the product, to combine the product with one or more additional components, e.g., a cement additive, to produce solid carbonate compositions from a bicarbonate rich product, etc. For embodiments where the reactor is configured to produce a carbonate product, such reactors include an input for the bicarbonate rich product, as well as an input for a source of cations (such as described above) which introduces the cations into the bicarbonate rich product in a manner sufficient to cause precipitation of solid carbonate compounds. Where desired, this reactor may be operably coupled to a separator configured to separate a precipitated carbonate mineral composition from a mother liquor, which are produced from the bicarbonate rich product in the reactor. In certain embodiments, the separator may achieve separation of a precipitated carbonate mineral composition from a mother liquor by a mechanical approach, e.g., where bulk excess water is drained from the precipitate by gravity or with the addition of a vacuum, mechanical pressing, filtering the precipitate from the mother liquor to produce a filtrate, centrifugation or by gravitational sedimentation of the precipitate and drainage of the mother liquor. The system may also include a washing station where bulk dewatered precipitate from the separator is washed, e.g., to remove salts and other solutes from the precipitate, prior to drying at the drying station. In some instances, the system further includes a drying station for drying the precipitated carbonate mineral composition produced by the carbonate mineral precipitation station. Depending on the particular drying protocol of the system, the drying station may include a filtration element, freeze drying structure, spray drying structure, etc. as described more fully above. The system may include a conveyer, e.g., duct, from the industrial plant that is connected to the dryer so that a gaseous waste stream (i.e., industrial plant flue gas) may be contacted directly with the wet precipitate in the drying stage. The resultant dried precipitate may undergo further processing, e.g., grinding, milling, in refining station, in order to obtain desired physical properties. One or more components may be added to the precipitate where the precipitate is used as a building material.

Continuous reactors of interest also include a non-slurry solid phase CO₂ sequestering carbonate material production location. This location is a region or area of the continuous reactor where a non-slurry solid phase CO₂ sequestering carbonate material is produced as a result of reaction of the divalent cations with bicarbonate ions of the bicarbonate rich product containing liquid. The reactor may be configured to produce any of the non-slurry solid phase CO₂ sequestering carbonate materials described above in the production location. In some instances, the production location is located at a distance from the divalent cation introduction location. While this distance may vary, in some instances the distance between the divalent cation introducer and the material production location ranges from 1 cm to 10 m, such as 10 cm to 1 m.

Where desired, the reactor may further include a retaining structure configured to retain non-slurry solid phase CO₂ sequestering carbonate materials in the material production location. Retaining structures of interest include filters, meshes or analogous structures (e.g., frits) which serve to maintain the non-slurry solid phase CO₂ sequestering carbonate materials in the production location despite the movement of the aqueous bicarbonate rich product containing liquid through the production location.

The reactor may have a flow modulator that is configured to maintain a desired flow rate of liquid through the reactor or portion thereof. For example, the flow modulator may be configured to maintain a constant and desired rate of liquid flow through the reactor, or may be configured to vary the flow rate of the liquid through different portions of the reactor, such that the reactor may have a first flow rate in a first portion and a second flow rate in a second portion. The flow modulator may be configured to provide for liquid flow through the reactor a value ranging from 0.1 m/s to 10 m/s, such as 1 m/s to 5 m/s.

The reactor may have a pressure modulator that is configured to maintain a desired pressure in the reactor or portion thereof. For example, the pressure modulator may be configured to maintain a constant and desired pressure throughout the reactor, or may be configured to vary the pressure in different portions of the reactor, such that the reactor may have a first pressure in a first portion and a second pressure in a second portion. For example, the reactor may have a higher pressure in the region of divalent cation introduction and a lower pressure in the region of material production. In such instances, the difference in pressure between any two regions may vary, ranging in some instances from 0.1 atm to 1,000 atm, such as 1 atm to 10 atm. The pressure modulator may be configured to provide for pressure in the reactor at a value ranging from 0.1 atm to 1,000 atm, such as 1 atm to 10 atm, which may vary among different regions of the reactor, e.g., as described above.

The reactor may have a temperature modulator that is configured to maintain a desired temperature in the reactor or portion thereof. For example, the temperature modulator may be configured to maintain a constant and desired temperature throughout the reactor, or may be configured to vary the temperature in different portions of the reactor, such that the reactor may have a first temperature in a first portion and a second temperature in a second portion of the reactor. The temperature modulator may be configured to provide for temperature in the reactor having a value ranging from −4 to 99° C., such as 0 to 80° C.

The reactor may include an agitator, e.g., to stir or agitate the non-slurry product during production. Any convenient type of agitator may be employed, including, but not limited to, a trommel, a vibration source, etc.

In some instances, the reactor, e.g., as described above, is operatively coupled to an aqueous bicarbonate rich product containing liquid production unit. While such units may vary, in some instances such units include a source of the CO₂ containing gas; a source of an aqueous medium; and a reactor configured to contact the CO₂ containing gas with the aqueous medium under conditions sufficient to produce a bicarbonate rich product. Any convenient bicarbonate buffered aqueous medium source may be included in the system. In certain embodiments, the source includes a structure having an input for aqueous medium, such as a pipe or conduit from an ocean, etc. Where the aqueous medium is seawater, the source may be an input that is in fluid communication with the sea water, e.g., such as where the input is a pipeline or feed from ocean water to a land based system or an inlet port in the hull of ship, e.g., where the system is part of a ship, e.g., in an ocean based system.

The reactor further includes an output conveyance for the bicarbonate rich product. In some embodiments, the output conveyance may be configured to transport the bicarbonate rich component to a storage site, such as an injection into subsurface brine reservoirs, a tailings pond for disposal or in a naturally occurring body of water, e.g., ocean, sea, lake, or river. In yet other embodiments, the output may transfer the bicarbonate rich product to a packaging station, e.g., for putting into containers and packaging with a hydraulic cement. Alternatively, the output may convey the bicarbonate rich product to second reactor, which may be configured to produce solid carbonate compositions, i.e., precipitates, from the bicarbonate rich product.

In some embodiments, the capture liquid has been subjected to an alkali enrichment protocol, such as those described in U.S. Pat. Nos. 9,707,513; 10,898,854; and U.S. patent application Ser. No. 17/127,074, the disclosures of which are incorporated herein in their entirety. By “alkali enrichment protocol” is meant a method or process of increasing the alkalinity of a liquid. The alkalinity increase of a given liquid may be manifested in a variety of different ways. In some instances, increasing the alkalinity of a liquid is manifested as an increase the pH of the liquid. For example, a liquid may be processed to remove hydrogen ions from the liquid to increase the alkalinity of the liquid. In such instances, the pH of the liquid may be increased by a desirable value, such as 0.10 or more, 0.20 or more, 0.25 or more, 0.50 or more, 0.75 or more, 1.0 or more, 2.0 or more, etc. In some instances, the magnitude of the increase in pH may vary, ranging in some instances from 0.1 to 10, such as 1 to 9, including 2.5 to 7.5, e.g., 3 to 7. As such, methods may increase the alkalinity of an initial liquid to produce a product liquid having a desired pH, where in some instances the pH of the product liquid ranges from 5 to 14, such as 6 to 13, including 7 to 12, e.g., 8 to 11, where the product liquid may be viewed as an enhanced alkalinity liquid. The increase in alkalinity of a liquid may also be manifested as an increase in the dissolved inorganic carbon (DIC) content of liquid. The DIC is the sum of the concentrations of inorganic carbon species in a solution, represented by the equation: DIC=[CO₂*]+[HCO₃⁻+CO⁻₃²⁻] where [CO₂*] is the sum of carbon dioxide ([CO₂]) and carbonic acid ([H₂CO₃]) concentrations, [HCO₃⁻] is the bicarbonate concentration and [CO₃²⁻] is the carbonate concentration in the solution. The DIC of the alkali enriched liquid may vary, and in some instances may be 500 ppm or greater, such as 5,000 ppm or greater, including 15,000 ppm or greater. In some instances, the DIC of the alkali enriched liquid may range from 500 to 20,000 ppm, such as 7,500 to 15,000 ppm, including 8,000 to 12,000 ppm. In some instances, alkali enrichment is manifested as an increase in the concentration of bicarbonate species, e.g., NaHCO₃, e.g., to a concentration ranging from 5 to 500 mMolar, such as 10 to 200 mMolar.

In some embodiments, the capture liquid includes ammonia. In such embodiments, an aqueous capture ammonia is contacted with the gaseous source of CO₂ under conditions sufficient to produce an aqueous ammonium carbonate. The aqueous capture ammonia may include any convenient water. Waters of interest from which the aqueous capture ammonia may be produced include, but are not limited to, freshwaters, seawaters, brine waters, reclaimed or recycled waters, produced waters and waste waters. The pH of the aqueous capture ammonia may vary, ranging in some instances from 9.0 to 13.5, such as 9.0 to 13.0, including 10.5 to 12.5. Further details regarding aqueous capture ammonias of interest are provided in PCT published application No. WO 2017/165849; the disclosure of which is herein incorporated by reference.

The CO₂ containing gas, e.g., as described above, may be contacted with the aqueous capture liquid, e.g., aqueous capture ammonia, using any convenient protocol. For example, contact protocols of interest include, but are not limited to: direct contacting protocols, e.g., bubbling the gas through a volume of the aqueous medium, concurrent contacting protocols, i.e., contact between unidirectionally flowing gaseous and liquid phase streams, countercurrent protocols, i.e., contact between oppositely flowing gaseous and liquid phase streams, crosscurrent contacting protocols, i.e. contact between a flowing liquid phase stream and a cross-flowing gaseous stream, and the like. Contact may be accomplished through use of infusers, bubblers, fluidic Venturi reactors, spargers, gas filters, sprays, trays, scrubbers, absorbers or packed column reactors, and the like, as may be convenient. In some instances, the contacting protocol may use a conventional absorber or an absorber froth column, such as those described in U.S. Pat. Nos. 7,854,791; 6,872,240; and 6,616,733; and in United States Patent Application Publication US-2012-0237420-A1; the disclosures of which are herein incorporated by reference. The process may be a batch or continuous process. In some instances, a regenerative froth contactor (RFC) may be employed to contact the CO₂ containing gas with the aqueous capture liquid, e.g., aqueous capture ammonia. In some such instances, the RFC may use a catalyst (such as described elsewhere), e.g., a catalyst that is immobilized on/to the internals of the RFC. Further details regarding a suitable RFC are found in U.S. Pat. No. 9,545,598, the disclosure of which is herein incorporated by reference.

In certain cases where the capture liquid includes ammonia, CO₂ capture systems may be additionally configured to combine the produced aqueous ammonium carbonate with a cation source under conditions sufficient to produce a solid CO₂ sequestering carbonate and an aqueous ammonium salt. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium and magnesium cations, may be employed. When cations are added to the aqueous ammonium carbonate, precipitation of carbonate solids, such as amorphous calcium carbonate when the divalent cations include Ca²⁺, may be produced with a stoichiometric ratio of one carbonate-species ion per cation.

In addition to carbonate production, e.g., as described above, aspects of the invention may further include regenerating an aqueous capture ammonia, e.g., as described above, from the aqueous ammonium salt. By “regenerating” an aqueous capture ammonium, it is meant processing the aqueous ammonium salt in a manner sufficient to generate an amount of ammonia from the aqueous ammonium salt. The percentage of input ammonium salt that is converted to ammonia during this regeneration step may vary, ranging in some instances from 20 to 80%, such as 35 to 55%.

Ammonia may be regenerated from an aqueous ammonium salt in this regeneration step using any convenient regeneration protocol. In some instances, a distillation protocol is employed. While any convenient distillation protocol may be employed, in some embodiments the employed distillation protocol includes heating the aqueous ammonium salt in the presence of an alkalinity source to produce a gaseous ammonia/water product, which may then be condensed to produce a liquid aqueous capture ammonia. The alkalinity source may vary, so long as it is sufficient to convert ammonium in the aqueous ammonium salt to ammonia. Any convenient alkalinity source may be employed.

The alkalinity source described herein may vary. Any convenient alkalinity source may be employed. Alkalinity sources that may be employed in this regeneration step include chemical agents. Chemical agents that may be employed as alkalinity sources include, but are not limited to, hydroxides, organic bases, super bases, oxides, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used.

Also of interest as alkalinity sources are silica sources. The source of silica may be pure silica or a composition that includes silica in combination with other compounds, e.g., minerals, so long as the source of silica is sufficient to impart desired alkalinity. In some instances, the source of silica is a naturally occurring source of silica. Naturally occurring sources of silica include silica containing rocks, which may be in the form of sands or larger rocks. Where the source is larger rocks, in some instances the rocks have been broken down to reduce their size and increase their surface area. Of interest are silica sources made up of components having a longest dimension ranging from 0.01 mm to 1 meter, such as 0.1 mm to 500 cm, including 1 mm to 100 cm, e.g., 1 mm to 50 cm. The silica sources may be surface treated, where desired, to increase the surface area of the sources. A variety of different naturally occurring silica sources may be employed. Naturally occurring silica sources of interest include, but are not limited to, igneous rocks, which rocks include: ultramafic rocks, such as Komatiite, Picrite basalt, Kimberlite, Lamproite, Peridotite; mafic rocks, such as Basalt, Diabase (Dolerite) and Gabbro; intermediate rocks, such as Andesite and Diorite; intermediate felsic rocks, such as Dacite and Granodiorite; and Felsic rocks, such as Rhyolite, Aplite—Pegmatite and Granite. Also of interest are man-made sources of silica. Man-made sources of silica include, but are not limited to, waste streams such as: mining wastes; fossil fuel burning ash; slag, e.g., iron and steel slags, phosphorous slag; cement kiln waste; oil refinery/petrochemical refinery waste, e.g., oil field and methane seam brines; coal seam wastes, e.g. gas production brines and coal seam brine; paper processing waste; water softening, e.g. ion exchange waste brine; silicon processing wastes; agricultural waste; metal finishing waste; high pH textile waste; and caustic sludge. Mining wastes include any wastes from the extraction of metal or another precious or useful mineral from the earth. Wastes of interest include wastes from mining to be used to raise pH, including: red mud from the Bayer aluminum extraction process; the waste from magnesium extraction for sea water, e.g. at Moss Landing, Calif.; and the wastes from other mining processes involving leaching. Ash from processes burning fossil fuels, such as coal fired power plants, create ash that is often rich in silica. In some embodiments, ashes resulting from burning fossil fuels, e.g., coal fired power plants, are provided as silica sources, including fly ash, e.g., ash that exits out the smoke stack, and bottom ash. Additional details regarding silica sources and their use are described in U.S. Pat. No. 9,714,406; the disclosure of which is herein incorporated by reference.

In embodiments of the invention, ash is employed as an alkalinity source. Of interest in certain embodiments is use of a coal ash as the ash. The coal ash as employed in this invention refers to the residue produced in power plant boilers or coal burning furnaces, for example, chain grate boilers, cyclone boilers and fluidized bed boilers, from burning pulverized anthracite, lignite, bituminous or sub-bituminous coal. Such coal ash includes fly ash which is the finely divided coal ash carried from the furnace by exhaust or flue gases; and bottom ash which collects at the base of the furnace as agglomerates.

Fly ashes are generally highly heterogeneous, and include of a mixture of glassy particles with various identifiable crystalline phases such as quartz, mullite, and various iron oxides. Fly ashes of interest include Type F and Type C fly ash. The Type F and Type C fly ashes referred to above are defined by CSA Standard A23.5 and ASTM C618 as mentioned above. The chief difference between these classes is the amount of calcium, silica, alumina, and iron content in the ash. The chemical properties of the fly ash are largely influenced by the chemical content of the coal burned (i.e., anthracite, bituminous, and lignite). Fly ashes of interest include substantial amounts of silica (silicon dioxide, SiO₂) (both amorphous and crystalline) and lime (calcium oxide, CaO, magnesium oxide, MgO).

The burning of harder, older anthracite and bituminous coal typically produces Class F fly ash. Class F fly ash is pozzolanic in nature, and typically contains less than 20% lime (CaO). Fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Alkali and sulfate (SO₄²⁻) contents are generally higher in Class C fly ashes. In some embodiments it is of interest to use Class C fly ash to regenerate ammonia from an aqueous ammonium salt, e.g., as mentioned above, with the intention of extracting quantities of constituents present in Class C fly ash so as to generate a fly ash closer in characteristics to Class F fly ash, e.g., extracting 95% of the CaO in Class C fly ash that has 20% CaO, thus resulting in a remediated fly ash material that has 1% CaO.

Fly ash material solidifies while suspended in exhaust gases and is collected using various approaches, e.g., by electrostatic precipitators or filter bags. Since the particles solidify while suspended in the exhaust gases, fly ash particles are generally spherical in shape and range in size from 0.5 μm to 100 μm. Fly ashes of interest include those in which at least about 80%, by weight, comprises particles of less than 45 microns. Also of interest in certain embodiments of the invention is the use of highly alkaline fluidized bed combustor (FBC) fly ash.

Also of interest in embodiments of the invention is the use of bottom ash. Bottom ash is formed as agglomerates in coal combustion boilers from the combustion of coal. Such combustion boilers may be wet bottom boilers or dry bottom boilers. When produced in a wet or dry bottom boiler, the bottom ash is quenched in water. The quenching results in agglomerates having a size in which 90% fall within the particle size range of 0.1 mm to 20 mm, where the bottom ash agglomerates have a wide distribution of agglomerate size within this range. The main chemical components of a bottom ash are silica and alumina with lesser amounts of oxides of Fe, Ca, Mg, Mn, Na and K, as well as sulphur and carbon.

Also of interest in certain embodiments is the use of volcanic ash as the ash. Volcanic ash is made up of small tephra, i.e., bits of pulverized rock and glass created by volcanic eruptions, less than 2 millimeters in diameter.

In one embodiment of the invention, cement kiln dusts, e.g., bypass dust (BPD) or cement kiln dust (CKD), are employed as an alkalinity source. The nature of the fuel from which the ash and/or dusts were produced, and the means of combustion of said fuel, will influence the chemical composition of the resultant ash and/or dusts. Thus ash and/or dusts may be used as a portion of the means for adjusting pH, or the sole means, and a variety of other components may be utilized with specific ashes and/or dusts, based on chemical composition of the ash and/or dusts.

In certain embodiments of the invention, slag is employed as an alkalinity source. The slag may be used as the sole pH modifier or in conjunction with one or more additional pH modifiers, e.g., ashes, etc. Slag is generated from the processing of metals, and may contain calcium and magnesium oxides as well as iron, silicon and aluminum compounds. In certain embodiments, the use of slag as a pH modifying material provides additional benefits via the introduction of reactive silicon and alumina to the precipitated product. Slags of interest include, but are not limited to, blast furnace slag from iron smelting, slag from electric-arc or blast furnace processing of iron and/or steel (steel slag), copper slag, nickel slag and phosphorus slag.

As indicated above, ash (or slag in certain embodiments) is employed in certain embodiments as the sole way to modify the pH of the water to the desired level. In yet other embodiments, one or more additional pH modifying protocols is employed in conjunction with the use of ash.

Also of interest in certain embodiments is the use of other waste materials, e.g., crushed or demolished or recycled or returned concretes or mortars, as an alkalinity source. When employed, the concrete dissolves releasing sand and aggregate which, where desired, may be recycled to the carbonate production portion of the process. Use of demolished and/or recycled concretes or mortars is further described below.

Of interest in certain embodiments are mineral alkalinity sources. The mineral alkalinity source that is contacted with the aqueous ammonium salt in such instances may vary, where mineral alkalinity sources of interest include, but are not limited to: silicates, carbonates, fly ashes, slags, limes, cement kiln dusts, etc., e.g., as described above. In some instances, the mineral alkalinity source comprises a rock, e.g., as described above. In embodiments, the alkalinity source is a geomass.

In some instances, the CO₂ gas/aqueous capture ammonia module comprises a combined capture and alkali enrichment reactor, the reactor comprising: a core hollow fiber membrane component (e.g., one that comprises a plurality of hollow fiber membranes); an alkali enrichment membrane component surrounding the core hollow fiber membrane component and defining a first liquid flow path in which the core hollow fiber membrane component is present; and a housing configured to contain the alkali enrichment membrane component and core hollow fiber membrane component, wherein the housing is configured to define a second liquid flow path between the alkali enrichment membrane component and the inner surface of the housing. In some instances, the alkali enrichment membrane component is configured as a tube and the hollow fiber membrane component is axially positioned in the tube. In some instances, the housing is configured as a tube, wherein the housing and the alkali enrichment membrane component are concentric. Aspects of the invention further include a combined capture and alkali enrichment reactor, e.g., as described above.

Further details regarding the ammonia mediated protocols, including “hot” and “cold” processes, are found in U.S. Pat. No. 10,322,371 and PCT application serial no. PCT/US2019/048790 published as WO 2020/047243, the disclosures of which are herein incorporated by reference.

In some embodiments, gaseous CO₂ capture systems employing gaseous CO₂ capture protocols involving absorption into a liquid include amine scrubbing (also referred to as “gas sweetening” or “amine sweetening”). Amine scrubbing is referred to herein in its conventional sense to describe the process of absorbing gaseous CO₂ into a liquid (e.g., aqueous solution) that comprises alkylamines (often referred to as “amines”). Amine scrubbers are described in, for example, G. T. Rochelle, Science 325, 1652 (2009), herein incorporated by reference in its entirety. The process of amine scrubbing involves the removal of acid gases (often referred to as “sour gas”) such as CO₂—and, where relevant, hydrogen sulfide (H₂S)—by contacting such gases with an amine solution to form salt complexes. Amine solutions may include, but are not limited to, monoethanolamine, diethanolamine, methyldiethanolamine, diglycolamine, or the like, and combinations thereof. Amine scrubbers of interest include a contactor column (e.g., a tray column, a packed column) in which gaseous CO₂ and amine solution are brought into contact. In embodiments, the contactor column includes an inlet at a bottom portion for receiving gaseous CO₂. This sour gas subsequently travels upward through the column. In some versions, the contactor column additionally includes an inlet at a top portion for receiving the lean amine solution, which solution subsequently travels downward through the column and thereby contacts the gaseous CO₂. Contactor columns may further include discharge for releasing a sweet gas (i.e., gas from which gaseous CO₂ has been removed) at a top portion of the column. In certain cases, the sweet gas discharge releases the sweet gas into the environment. Contactor columns may additionally include a discharge for releasing rich amine (i.e., CO₂—and, in some cases, H₂S-rich) solution from the column.

In embodiments, the amine scrubbers additionally include a regenerator column (often referred to as a “stripper column”). Regenerator columns of interest receive rich amine from the discharge of the contactor column and separate CO₂—and, where desired, H₂S—from the rich amine to regenerate the lean amine solution for subsequent use in the contactor column. In certain cases, the regenerator column includes a rich amine inlet located at the top of the column. Rich amine inserted at the top of the column subsequently flows down the column and is heated (e.g., by steam). The heat is configured to separate the acid gasses from the amine solution. The acid gasses travel upwards to an acid gas discharge where they may be collected for subsequent use (e.g., in an industrial process), sequestered, or disposed of, as desired. The subject regenerator may have any convenient configuration and may, in certain instances, include a matrix configuration, internal exchange configuration, flashing feed configuration or a multi-pressure with split feed configuration.

As discussed above, in certain cases, the gaseous CO₂ capture system employs a gaseous CO₂ capture protocol involving membrane transport. By “membrane transport” it is meant that at least one portion of the gaseous CO₂ capture protocol includes the separation of two or more components via transport across a membrane. Exemplary CO₂ capture protocols involving membrane transport are described in U.S. Pat. No. 7,132,090; the disclosure of which is herein incorporated by reference in its entirety. In certain versions, the gaseous CO₂ capture system includes a microporous gas diffusion membrane configured to facilitate the transport of gaseous CO₂ therethrough. In some instances, gaseous CO₂ (e.g., from one or more of the sources described above) is diffused through the membrane into an aqueous medium (e.g., such as those described above). In some instances, the aqueous medium is a capture liquid (e.g., such as those described above). In such instances, the capture liquid may subject to any of the applicable processes described herein with respect to such capture liquids. Suitable membranes include, but are not limited to a polypropylene gas exchange membrane, ePTFE (GORE-TEX), Zeolites, chytosan, polyvinylpyrollindine, cellulose acetate, immobilized liquid membranes, or the like.

In some cases, CO₂-rich fluid emerging from the gas diffusion membrane is passed by a matrix that contains a catalyst specific for CO₂. For example, in some cases, the catalyst is carbonic anhydrase and the passage of the fluid past the carbonic anhydrase produces carbonic acid. Once carbonic acid is formed, it spontaneously dissociates and forms a pH dependent equilibrium between carbonate ions and bicarbonate. In certain embodiments, gaseous CO₂ capture systems include a base source (i.e., a substance that, when added to a solution, raises the pH of said solution). Base from the base source may, in certain cases, be applied to shift the equilibrium in favor of carbonate ions thereby accelerating the rate at which CO₂ enters the fluid.

In other instances, the subject gaseous CO₂ capture protocol employs membrane transport in an alkali enrichment protocol (e.g., such as those described above). In other words, the alkali enrichment protocol is a membrane-mediated protocol. By “membrane-mediated protocol” it is meant a process or method which employs a membrane at some time during the method. As such, membrane mediated alkali enrichment protocols are those alkali enrichment processes in which a membrane is employed at some time during the process. Exemplary membrane-mediated protocols are described in, for example, U.S. Pat. Nos. 9,707,513; 10,898,854; and U.S. Patent Application Publication No. 2021/0162340; the disclosures of which are herein incorporated by reference.

While a given membrane mediated alkali enrichment protocol may vary, in some instances the membrane mediated protocol includes contacting a first liquid, e.g., a feed liquid, and a second liquid, e.g., a draw liquid, to opposite sides of a membrane. In one example, first and second liquids are flowed past opposite sides of a membrane in a co- or counter-current fashion, resulting in increased alkalinity of the first liquid and decreased alkalinity of the second liquid.

Where desired, a thermodynamic force is employed that facilitates the alkalinity increase of the first (i.e., initial) liquid. Any convenient thermodynamic force or combination of forces may be employed, where thermodynamic driving forces that may be employed include, but are not limited to: osmotic force, ionic concentration, mechanical pressure, alkalinity, temperature, other chemical reactions, etc., and combinations thereof, e.g., combinations of osmotic force and mechanical pressure, e.g., as occurs in pressure assisted forward osmosis.

In some instances, the membrane mediated alkali enrichment protocol is one that employs an osmotic force to facilitate the alkalinity enhancement of the first liquid. Protocols of these embodiments may be referred to osmotic pressure mediated protocols. The phrase “osmotic pressure mediated protocol” is employed herein to refer to a process characterized by the presence of an osmotic pressure driving force, e.g., in the form of an osmotic pressure gradient, such that a first liquid (e.g., a draw liquid) of high solute concentration relative to that of a second liquid (e.g., a feed liquid) is used to induce a net flow of water through a membrane into the first (draw) liquid from the second (feed) liquid, thus effectively separating at least a portion of the water component of the feed from its solutes. In some embodiments, the draw and feed liquids differ from each other in terms of osmotic potential, where the osmotic potential of a given draw liquid will be higher than the feed liquid with which it is employed.

In some embodiments, the gaseous CO₂ capture system employs a gaseous CO₂ capture protocol that removes one or more additional pollutants from at least one gaseous CO₂ source of the plurality of gaseous CO₂ sources. Additional pollutants that may be removed by the subject systems include, one or more additional non-CO₂ components, for example only, water, NOx (mononitrogen oxides: NO and NO₂), SOx (monosulfur oxides: SO, SO₂ and SO₃), VOC (volatile organic compounds), heavy metals such as, but not limited to, mercury, and particulate matter (particles of solid or liquid suspended in a gas). In these embodiments, gaseous CO₂ capture system may include one or more oxidizing systems, adsorption systems, absorption systems, catalysts, electrostatic precipitators, fabric filters, or the like.

### Gaseous CO₂ Disposition

Aspects of the gaseous CO₂ capture systems described herein additionally carry out gaseous CO₂ capture protocols that provide for a gaseous CO₂ disposition. By “gaseous CO₂ disposition”, it is meant the conversion of the gaseous CO₂ into a storage-stable format that may be disposed of and/or applied (e.g., in an industrial process, a construction process) in such a way that the gaseous CO₂ does not return to the surrounding atmosphere. In some embodiments, the gaseous CO₂ capture system employs a gaseous CO₂ capture protocol that provides for a gaseous CO₂ disposition via mineralization, geologic sequestration, biological sequestration, chemical conversion, electrochemical conversion and combinations thereof.

In some embodiments, the gaseous CO₂ capture system employs a gaseous CO₂ capture protocol that provides for a gaseous CO₂ disposition via mineralization (i.e., via a mineralization capture system). By “mineralization” it is meant that the CO₂ becomes embodied in CO₂ sequestering solid composition (e.g., a CO₂ embodied cement or a CO₂ embodied aggregate). The gaseous CO₂ capture system may mineralize the captured gaseous CO₂ via any convenient protocol. In some embodiments, captured carbon (e.g., in the form of bicarbonate rich product, as discussed above) may be employed as a cement additive (e.g., as a setting fluid or in conjunction with another setting liquid), either as produced or upon combination with other components, as desired. Exemplary methods and systems for producing CO₂ embodied cement are described in U.S. Pat. Nos. 9,714,406 and 10,711,236, the disclosures of which are incorporated by reference in their entirety.

In some embodiments, systems are configured to set the initial CO₂ sequestering solid composition. The initial CO₂ sequestering solid composition can include not only compounds in the solid state, but also compounds in a liquid state, e.g., liquid water. “Setting” the initial CO₂ sequestering solid composition is used interchangeably with “drying” the solid composition and includes placing the solid composition in an environment such that there is evaporation of liquid from the solid composition. By removing a liquid from the solid composition, the chemical composition and thereby physical properties of the solid composition can be altered, e.g., a reduced volume of liquid can cause solutes dissolved in the liquid to transition to a solid state. For example, the initial CO₂ sequestering solid composition can be placed on a solid surface so that it is not in contact with another liquid, e.g., so that liquid from the solid composition can evaporate and the solid composition will not gain liquid from another liquid. In some cases, the step includes ways of increasing the rate of evaporation, e.g., flowing a gas past the solid composition, applying a reduced gas pressure to the solid composition, increasing the temperature of the solid composition, or a combination thereof. Flowing the gas past the solid composition can be performed, for example, with a fan. A pump, e.g., a vacuum pump, can be employed to reduce the gas pressure, thereby increasing the rate of evaporation. The temperature of the solid composition can be increased, e.g., using an electric heater or a natural gas heater, to a temperature such as ranging from 25° C. to 95° C., such as from 35° C. to 80° C. In embodiments, the setting can be done simply by air drying for 1-30 days or by drying with elevated temperature (for minutes—hours at 30-200° C.). In some instances, setting is characterized by partial mineral conversion from vaterite/ACC to calcite/aragonite (not fully converted) which prevents aggregates from falling apart when in contact with solutions.

Where desired, the CO₂ sequestering solid may be cured, e.g., prior to and/or after steam treatment, as desired. As used herein, “curing” means altering the chemical structure or composition of a compound. In some cases, curing includes changing a compound in the initial CO₂ sequestering solid composition from a first polymorph to a second polymorph. The term “polymorph” refers to compounds that have the same empirical formula but different crystal structures. “Empirical formula” refers to the ratio of atoms in a molecule, e.g., the empirical formula of water is H₂O. Calcite, aragonite, and vaterite are polymorphs of calcium carbonate (CaCO₃) since they all have the same empirical formula of CaCO₃, but they differ from each other in crystal structure, e.g., the crystal structure space groups of calcite, aragonite, and vaterite are R3c, Pmcn, and P6₃/mmc, respectively. In some cases, the polymorph is amorphism, i.e., wherein the solid is not crystalized and instead lacks long-range order. For example, the solid might include amorphous calcium carbonate (ACC). In an exemplary embodiment, the solid includes a first polymorph of calcium carbonate and the curing step converts some or all of the first polymorph of calcium carbonate into a second polymorph of calcium carbonate. In some cases, the first crystal structure is vaterite or amorphous calcium carbonate, and the second crystal structure is aragonite or calcite. In some cases, curing includes changing a first compound into a second compound, i.e., wherein the empirical formula of the compound changes during the curing. Details regarding curing and protocols therefore are further provided in U.S. Provisional Application Ser. No. 63/128,487 (attorney docket no. BLUE-048PRV; filed on Dec. 21, 2020); the disclosure of which is herein incorporated by reference.

In embodiments, settable compositions of the invention, such as concretes and mortars, are produced by combining a hydraulic cement with an amount of aggregate (fine for mortar, e.g., sand; coarse with or without fine for concrete) and water, either at the same time or by pre-combining the cement with aggregate, and then combining the resultant dry components with water. The choice of coarse aggregate material for concrete mixes using cement compositions of the invention may have a minimum size of about ⅜ inch and can vary in size from that minimum up to one inch or larger, including in gradations between these limits. Finely divided aggregate is smaller than ⅜ inch in size and again may be graduated in much finer sizes down to 200-sieve size or so. Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

By “settable cementitious composition” is meant a flowable composition that is prepared from a cement and a setting liquid, where the flowable composition sets into a solid product following preparation. Settable cementitious compositions of the invention are prepared from combination of a cement, a setting liquid and a BRP additive/admixture (e.g., as described above), where the compositions may further include one or more additional components, such as but not limited to: aggregates, chemical admixtures, mineral admixtures, etc.

The liquid phase, e.g., aqueous fluid, with which the dry component is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

In some instances, the product bicarbonate rich product compositions are employed as bicarbonate additives for cements. The term “bicarbonate additive” as used herein means any composition, which may be liquid or solid, that includes bicarbonate (HCO₃) ions, or a solid derivative thereof. The bicarbonate additive employed to produce a given settable cementitious composition may be a liquid or solid. When present as a solid, the solid is a dehydrated version of a liquid bicarbonate additive. The solid may be one that is produced from a liquid bicarbonate additive using any convenient protocol for removed water from the liquid, e.g., evaporation, freeze drying, etc. Upon combination with a suitable volume of water, the resultant solid dissolves in the water to produce a liquid bicarbonate additive, e.g., as described above. In some instances, reconstitution is achieved by combining the dry bicarbonate additive with a sufficient amount of liquid, e.g., aqueous medium, such as water, where the liquids to solids ratio employed may vary, and in some instances ranges from 1,000,000 to 1, such as 100,000 to 10. Solid bicarbonate additives may include a variety of different particle sizes and particle size distributions. For example, in some embodiments a solid bicarbonate additive may include particulates having a size ranging from 1 to 10,000 μm, such as 10 to 1,000 μm and including 50 to 500 μm.

Aspects of the invention further include settable cementitious compositions prepared from the bicarbonate rich product additives and admixtures. Admixtures of interest include, but are not limited to: set accelerators, set retarders, air-entraining agents, de-foamers, alkali-reactivity reducers, bonding admixtures, dispersants, coloring admixtures, corrosion inhibitors, damp-proofing admixtures, gas formers, permeability reducers, pumping aids, shrinkage compensation admixtures, fungicidal admixtures, germicidal admixtures, insecticidal admixtures, rheology modifying agents, wetting agents, strength enhancing agents, water repellents, etc.

The term “cement” as used herein refers to a particulate composition that sets and hardens after being combined with a setting fluid, e.g., an aqueous solution, such as water. The particulate composition that makes up a given cement may include particles of various sizes. In some instances, a given cement may be made up of particles having a longest cross-sectional length (e.g., diameter in a spherical particle) that ranges from 1 nm to 100 μm, such as 10 nm to 20 μm and including 15 nm to 10 μm.

Cements of interest include hydraulic cements. The term “hydraulic cement” as used herein refers to a cement that, when mixed with a setting fluid, hardens due to one or more chemical reactions that are independent of the water content of the mixture and are stable in aqueous environments. As such, hydraulic cements can harden underwater or when constantly exposed to wet weather conditions. Hydraulic cements of interest include, but are not limited to Portland cements, modified Portland cements, and blended hydraulic cements.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

In some cases, the subject gaseous CO₂ capture system is mineralized in an aggregate (e.g., a carbonate aggregate or a carbonate-coated aggregate). The term “aggregate” is used in its conventional sense to refer to a granular material, i.e., a material made up of grains or particles. As the aggregate is a carbonate aggregate, the particles of the granular material include one or more carbonate compounds, where the carbonate compound(s) component may be combined with other substances (e.g., substrates) or make up the entire particles, as desired. Exemplary systems and methods are described in U.S. Pat. No. 7,914,685 and Published PCT Application Publication No. WO 2020/154518, the disclosures of which are herein incorporated by reference in their entirety.

In certain cases, systems of the invention are configured to produce carbonate coated aggregates, e.g., for use in concretes and other applications. The carbonate coated aggregates may be conventional or lightweight aggregates. The CO₂ sequestering aggregate compositions include aggregate particles having a core and a CO₂ sequestering carbonate coating on at least a portion of a surface of the core. The CO₂ sequestering carbonate coating is made up of a CO₂ sequestering carbonate material, e.g., as described above.

In some instances, the invention includes producing the solid phase CO₂ sequestering carbonate material in association with a seed structure. By seed structure is meant a solid structure or material that is present in the flowing liquid, e.g., in the material production zone, prior to divalent cation introduction into the liquid. By “in association with” is meant that the material is produced on at least one of: a surface or in a depression, e.g., a pore, crevice, etc., of the seed structure. In such instances, a composite structure of the carbonate material and the seed structure is produced. In some instances, the product carbonate material coats a portion, if not all of, the surface of a seed structure. In some instances, the product carbonate materials fills in a depression of the seed structure, e.g., a pore, crevice, fissure, etc.

Seed structures may vary widely as desired. The term “seed structure” is used to describe any object upon and/or in which the product carbonate material forms. Seed structures may range from singular objects or particulate compositions, as desired. Where the seed structure is a singular object, it may have a variety of different shapes, which may be regular or irregular, and a variety of different dimensions. Shapes of interest include, but are not limited to, rods, meshes, blocks, etc. Exemplary systems and methods involving the production of carbonate coated aggregates are described in U.S. Pat. Nos. 9,993,799, 10,766,015; U.S. patent application Ser. No. 16/943,540; as well as Published PCT Application Publication No. WO 2020/154518; the disclosures of which are herein incorporated by reference.

In some instances, the aggregate is produced by a protocol in which a carbonate slurry, e.g., as described above, is introduced into a revolving drum and mixed in the revolving drum under conditions sufficient to produce a carbonate aggregate. In some instances, the carbonate slurry is introduced into the revolving drum with an aggregate substrate, e.g., an aggregate such as described above, and then mixed in the revolving drum to produce a carbonate coated aggregate. In certain cases, the slurry (and substrate) are introduced into the revolving drum and mixing is commenced shortly after production of the carbonate slurry, such as within 12 hours, such as within 6 hours and including within 4 hours of preparing the carbonate slurry. In some instances, the entire process (i.e., from commencement of slurry preparation to obtainment of carbonate aggregate product) is performed in 15 hours or less, such as 10 hours or less, including 5 hours or less, e.g., 3 hours or less, including 1 hour less. Further details regarding such protocols may be found in Published PCT Application Publication No. WO 2020/154518; the disclosure of which is herein incorporated by reference.

Also of interest are formed building materials. The formed building materials of the invention may vary greatly. By “formed” is meant shaped, e.g., molded, cast, cut or otherwise produced, into a man-made structure defined physical shape, i.e., configuration. Formed building materials are distinct from amorphous building materials, e.g., particulate (such as powder) compositions that do not have a defined and stable shape, but instead conform to the container in which they are held, e.g., a bag or other container. Illustrative formed building materials include, but are not limited to: bricks; boards; conduits; beams; basins; columns; drywalls etc. Further examples and details regarding formed building materials include those described in United States Published Application No. US20110290156; the disclosure of which is herein incorporated by reference.

Also of interest are non-cementitious manufactured items that include the product of the invention as a component. Non-cementitious manufactured items of the invention may vary greatly. By non-cementitious is meant that the compositions are not hydraulic cements. As such, the compositions are not dried compositions that, when combined with a setting fluid, such as water, set to produce a stable product. Illustrative compositions include, but are not limited to: paper products; polymeric products; lubricants; asphalt products; paints; personal care products, such as cosmetics, toothpastes, deodorants, soaps, and shampoos; human ingestible products, including both liquids and solids; agricultural products, such as soil amendment products and animal feeds; etc. Further examples and details non-cementitious manufactured items include those described in U.S. Pat. No. 7,829,053; the disclosure of which is herein incorporated by reference.

In some embodiments, the precipitated product may include one or more different carbonate compounds, such as two or more different carbonate compounds, e.g., three or more different carbonate compounds, five or more different carbonate compounds, etc., including non-distinct, amorphous carbonate compounds. Carbonate compounds of precipitated products of the invention may be compounds having a molecular formulation Xₘ(CO₃)ₙ where X is any element or combination of elements that can chemically bond with a carbonate group or its multiple, wherein X is in certain embodiments an alkaline earth metal and not an alkali metal; wherein m and n are stoichiometric positive integers. These carbonate compounds may have a molecular formula of Xₘ(CO₃)ₙ·iH₂O, where there are i (i being one or more) structural waters in the molecular formula. The amount of carbonate in the product, e.g., as determined by coulometry using the protocol described as coulometric titration, may be 10% or more, such as 25% or more, 50% or more, including 60% or more.

The carbonate compounds of the precipitated products may include a number of different cations, such as but not limited to ionic species of: calcium, magnesium, sodium, potassium, sulfur, boron, silicon, strontium, and combinations thereof. Of interest are carbonate compounds of divalent metal cations, such as calcium and magnesium carbonate compounds. Specific carbonate compounds of interest include, but are not limited to: calcium carbonate minerals, magnesium carbonate minerals and calcium magnesium carbonate minerals. Calcium carbonate minerals of interest include, but are not limited to: calcite (CaCO₃), aragonite (CaCO₃), vaterite (CaCO₃), ikaite (CaCO₃·6H₂O), and amorphous calcium carbonate (CaCO₃). Magnesium carbonate minerals of interest include, but are not limited to magnesite (MgCO₃), barringtonite (MgCO₃·2H₂O), nesquehonite (MgCO₃·3H₂O), lanfordite (MgCO₃·5H₂O), hydromagnisite, and amorphous magnesium carbonate (MgCO₃). Calcium magnesium carbonate minerals of interest include, but are not limited to dolomite (CaMg)(CO₃)₂), huntite (Mg₃Ca(CO₃)₄), sergeevite (Ca₂Mg₁₁(CO₃)₁₃·H₂O) and amorphous calcium magnesium carbonate. Also of interest are carbonate compounds formed with Na, K, Al, Ba, Cd, Co, Cr, As, Cu, Fe, Pb, Mn, Hg, Ni, V, Zn, etc. The carbonate compounds of the product may include one or more waters of hydration, or may be anhydrous. In some instances, the amount by weight of magnesium carbonate compounds in the precipitate exceeds the amount by weight of calcium carbonate compounds in the precipitate. For example, the amount by weight of magnesium carbonate compounds in the precipitate may exceed the amount by weight calcium carbonate compounds in the precipitate by 5% or more, such as 10% or more, 15% or more, 20% or more, 25% or more, 30% or more. In some instances, the weight ratio of magnesium carbonate compounds to calcium carbonate compounds in the precipitate ranges from 1.5-5 to 1, such as 2-4 to 1 including 2-3 to 1. In some instances, the precipitated product may include hydroxides, such as divalent metal ion hydroxides, e.g., calcium and/or magnesium hydroxides.

Further details regarding carbonate production and methods of using the carbonated produced thereby are provided in U.S. Pat. Nos. 9,714,406; 10,711,236; 10,203,434; 9,707,513; 10,287,439; 9,993,799; 10,197,747; and 10,322,371; as well as published PCT Application Publication Nos. WO 2020/047243 and WO 2020/154518; the disclosures of which are herein incorporated by reference.

As discussed above, aspects of the invention additionally include geological sequestration. During the production of solid carbonate compositions from the bicarbonate rich product or component thereof (e.g., LCP), one mole of CO₂ may be produced for every 2 moles of bicarbonate ion from the bicarbonate rich product or component thereof (e.g., LCP). Contact of the bicarbonate rich product with the cation source results in production of a substantially pure CO₂ product gas. The phrase “substantially pure” means that the product gas is pure CO₂ or is a CO₂ containing gas that has a limited amount of other, non-CO₂ components.

Following production of a CO₂ product gas, aspects of the invention may include injecting the product CO₂ gas into a subsurface geological location to sequester CO₂ (i.e., geological sequestration). By injecting is meant introducing or placing the CO₂ product gas into a subsurface geological location. Subsurface geological locations may vary, and include both subterranean locations and deep ocean locations. Subterranean locations of interest include a variety of different underground geological formations, such as fossil fuel reservoirs, e.g., oil fields, gas fields and un-mineable coal seams; saline reservoirs, such as saline formations and saline-filled basalt formations; deep aquifers; porous geological formations such as partially or fully depleted oil or gas formations, salt caverns, sulfur caverns and sulfur domes; etc.

In some instances, the CO₂ product gas may be pressurized prior to injection into the subsurface geological location. To accomplish such pressurization the gaseous CO₂ can be compressed in one or more stages with, where desired, after cooling and condensation of additional water. The modestly pressurized CO₂ can then be further dried, where desired, by conventional methods such as through the use of molecular sieves and passed to a CO₂ condenser where the CO₂ is cooled and liquefied. The CO₂ can then be efficiently pumped with minimum power to a pressure necessary to deliver the CO₂ to a depth within the geological formation or the ocean depth at which CO₂ injection is desired. Alternatively, the CO₂ can be compressed through a series of stages and discharged as a super critical fluid at a pressure matching that necessary for injection into the geological formation or deep ocean. Where desired, the CO₂ may be transported, e.g., via pipeline, rail, truck, sea or other suitable protocol, from the production site to the subsurface geological formation.

In some instances, the CO₂ product gas is employed in an enhanced oil recovery (EOR) protocol. Enhanced Oil Recovery (abbreviated EOR) is a generic term for techniques for increasing the amount of crude oil that can be extracted from an oil field. Enhanced oil recovery is also called improved oil recovery or tertiary recovery. In EOR protocols, the CO₂ product gas is injected into a subterranean oil deposit or reservoir.

CO₂ gas production and sequestration thereof is further described in U.S. application Ser. No. 14/861,996, the disclosure of which is herein incorporated by reference.

In additional embodiments, the gaseous CO₂ capture system employs a gaseous CO₂ capture protocol that provides for a gaseous CO₂ disposition via chemical conversion. By “chemical conversion”, it is meant that, in some embodiments of chemical conversion CO₂ is hydrogenated to produce useful fuels such as carbon monoxide (CO), methane (CH₄), formic acid (H₂CO₂) or methanol (CH₃OH). In some cases, chemical conversion of CO₂ means using CO₂ as a raw material to synthesize major commodity chemicals such as salicylic acid, urea, cyclic carbonates, polycarbonates, and the like. In yet other cases, chemical conversion of CO₂ means the dry reformation with methane (CH₄) to yield synthesis gas (2CO+2H₂).

In other embodiments, the gaseous CO₂ capture system employs a gaseous CO₂ capture protocol that provides for a gaseous CO₂ disposition via electrochemical conversion. By “electrochemical conversion”, it is meant that, in some cases the gaseous CO₂ disposition uses electronically- and ionically-conducting circuits to mobilize electrons and ions to drive a chemical conversion of CO₂ electrochemical reactions that produce useful products, e.g., such as described above.

In some instances, CO₂ sequestered by the present invention may be employed in albedo enhancing applications. Albedo, i.e., reflection coefficient, refers to the diffuse reflectivity or reflecting power of a surface. It is defined as the ratio of reflected radiation from the surface to incident radiation upon it. Albedo is a dimensionless fraction, and may be expressed as a ratio or a percentage. Albedo is measured on a scale from zero for no reflecting power of a perfectly black surface, to 1 for perfect reflection of a white surface. While albedo depends on the frequency of the radiation; as used herein Albedo is given without reference to a particular wavelength and thus refers to an average across the spectrum of visible light, i.e., from about 380 to about 740 nm. Exemplary systems and methods for enhancing albedo can be found in U.S. Pat. No. 10,203,434; and U.S. Patent Application Publication No. 2019/0179061; the disclosures of which are herein incorporated by reference.

Aspects of the invention include associating with a surface of interest an amount of a highly reflective microcrystalline or amorphous material composition effective to enhance the albedo of the surface by a desired amount, such as the amounts listed above. The material composition may be associated with the target surface using any convenient protocol. As such, the material composition may be associated with the target surface by incorporating the material into the material of the object having the surface to be modified. For example, where the target surface is the surface of a building material, such as a roof tile or concrete mixture, the material composition may be included in the composition of the material so as to be present on the target surface of the object. Alternatively, the material composition may be positioned on at least a portion of the target surface, e.g., by coating the target surface with the composition. Where the surface is coated with the material composition, the thickness of the resultant coating on the surface may vary, and in some instances may range from 0.1 mm to 25 mm, such as 2 mm to 20 mm and including 5 mm to 10 mm. Applications in use as highly reflective pigments in paints and other coatings like photovoltaic solar panels are also of interest.

In the following sections, particular embodiments of the invention are described in greater detail:

### Power Plants

As discussed above, aspects of the invention include power plants. Power plants of interest include those having a plurality of CO₂ gas point source emitters, a common CO₂ capture system operatively coupled to each of the CO₂ gas point source emitters, and a controller configured to control the CO₂ gas point source emitters and common CO₂ capture system in a manner such that at least one gaseous CO₂ capture performance metric of the power plant is improved relative to a suitable control. The power plant described herein may be any suitable power plant. In some cases, the power plant is configured to generate electrical power from fossil fuels (e.g., coal, oil, and/or natural gas).

Any suitable number of CO₂ gas point source emitters may be employed in the subject power plants. In certain cases, the number of CO₂ gas point source emitters in the plurality of CO₂ gas point source emitters ranges from 2 to 10, such as 2 to 5, and including 2 to 3. In some embodiments, the power plant includes 2 (i.e., a first and second) CO₂ gas point source emitters. In some versions, one or more CO₂ gas point source emitters are flue-gas stacks. For example, in some embodiments of the power plant having first and second CO₂ gas point source emitters, both the first and second CO₂ gas point source emitters are flue-gas stacks.

As discussed above, power plants of interest include a common CO₂ capture system. Any suitable common CO₂ capture system may be employed, including, but not limited to, those described above. For example, gaseous CO₂ capture protocols of interest include absorption into a liquid or solid, adsorption, membrane transport and combinations thereof. In some embodiments, the common CO₂ capture system includes a capture liquid that is circulated among the different CO₂ gas point sources. In such embodiments, gaseous CO₂ is extracted by the capture liquid from each CO₂ gas point source. The capture liquid may subsequently be transported to a common location for treatment (i.e., mineralization and/or regeneration, as described above). As such, in certain cases, the common CO₂ capture system comprises a mineralization capture system. In certain embodiments, the mineralization capture system produces a solid carbonate material. The solid carbonate material may, in some cases, include a building material. Building materials of interest include, for example, aggregates, highly reflective microcrystalline or amorphous material compositions and cementitious compositions (i.e., cements). In some embodiments, the building materials are formed building materials, including, but not limited to, bricks; boards; conduits; beams; basins; columns; drywalls etc.

In other embodiments, the common CO₂ capture system comprises a scrubber system. The scrubber system may, in some instances, include an amine scrubber system. Such systems are described above and involve the removal of acid gases such as CO₂—and, where relevant, hydrogen sulfide (H₂S)—by contacting such gases with an amine solution to form salt complexes. In embodiments of the power plants including a scrubber system, the CO₂ gas point sources are a part of the same amine scrubber system. For example, in certain cases, each CO₂ gas point source is associated with an individual contactor column in which the gaseous CO₂ from the CO₂ gas point source is captured such that rich amine is generated. The rich amine from each of the contactor columns may be connected via a series of conduits to a common regenerator column in which lean amine is regenerated and pure gaseous CO₂ is captured. In other cases, each CO₂ gas point source is connected to the same contactor column.

As discussed above, power plants of the subject invention include a controller configured to control the CO₂ gas point source emitters and common CO₂ capture system in a manner such that at least one gaseous CO₂ capture performance metric of the power plant is improved relative to a suitable control. Any suitable CO₂ capture performance metric may be improved. In some embodiments, the gaseous CO₂ capture performance metric is amount of capture CO₂. In such embodiments, the controller may be configured to modulate the manner in which gaseous CO₂ is emitted from the CO₂ gas point sources. For example, in certain cases where the CO₂ gas point sources are flue gas stacks, the controller may be configured to modulate flue gas rates (i.e., flow rate) in each of the flue-gas stacks. In additional embodiments, the controller is configured to control the rate with which the amine scrubbing solution is provided to the contactor column(s). As is known in the art, optimal conditions for amine scrubbing exist when the partial pressure of CO₂ within the contactor column is high and the flow rate of the amine scrubbing solution is low. In some embodiments where each CO₂ gas point source is associated with a contactor column, the controller may shift the flue gas rates in each CO₂ gas point source as well as the rates of amine scrubbing solution passing through each contactor column so that the amount of CO₂ captured is maximized. In some embodiments, shifting the amine scrubbing solution rates and the flue-gas rates reduces the rate with which the amines in the amine scrubbing solution are degenerated.

In some instances, a controller may be employed to modulate the plurality of gaseous CO₂ sources so that the highest concentration of CO₂ enters the gaseous CO₂ capture system at the lowest flue gas flow rate. For example, if in a plurality of gaseous CO₂ sources, the concentration of CO₂ in the flue gas of emitter A is 95 wt % CO₂, the concentration of CO₂ in the flue gas of emitter B is 5 wt % CO₂, the concentration of emitter C is 22 wt % CO₂, and the concentration of CO₂ in the flue gas of emitter D is 12 wt % CO₂, then the controller might modulate the flue gas rate of the plurality of gaseous CO₂ sources such that the majority of plurality of gaseous CO₂ sources is emitter A, followed by minority makeup from emitter C, emitter D, and finally emitter A, i.e., the controller is modulating the flue gas rate of each emitter so as to maximize the wt % CO₂ in the plurality of gaseous CO₂ sources all while at least one gaseous CO₂ capture performance metric of the system is improved relative to a suitable control. In other embodiments, such as a power plant comprising a first and second CO₂ gas source wherein the concentration of CO₂ in the gas sources is less than or equal to 5 wt % CO₂, the control may increase the flue gas rate so as to increase the total amount of CO₂ exposed to the CO₂ capture system, i.e., so as to maximize the amount of CO₂ being captured in the CO₂ capture system.

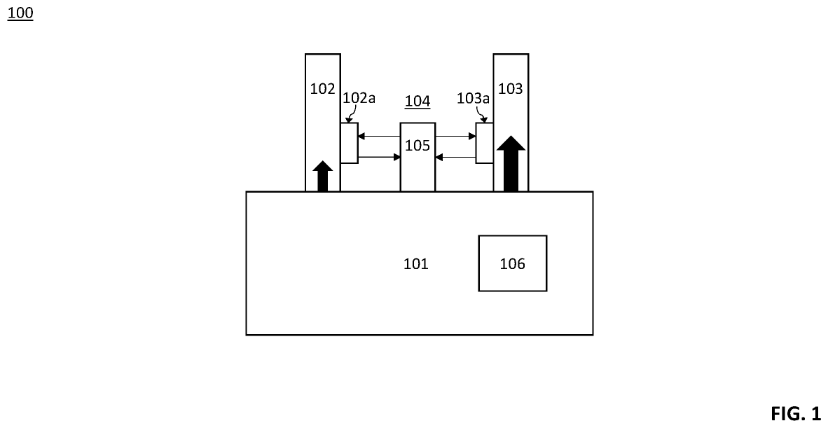

FIG. 1 depicts a gaseous CO₂ capture system 100 including a power plant 101 according to certain embodiments of the invention. Power plant 101 includes a first CO₂ gas point source 102 and a second CO₂ gas point source 103. In the example of FIG. 1, both first CO₂ gas point source 102 and second CO₂ gas point source 103 are flue-gas stacks, and share amine scrubber system 104 in common. First CO₂ gas point source 102 is associated with contactor column 102a such that gaseous CO₂ is contacted and captured by amine scrubbing solution passing therethrough. Similarly, second CO₂ gas point source 103 is associated with contactor column 103a such that gaseous CO₂ is contacted and captured by amine scrubbing solution passing therethrough. Rich amine solution produced in contactor columns 102a and 103a is subsequently transferred to a shared regenerator column 105. The regenerator column 105 is configured to regenerate the amine solution, which is subsequently returned to contactor columns 102a and 103a.

The power plant of FIG. 1 is additionally configured to control the CO₂ gas point source emitters (102 and 103) and common CO₂ capture system in a manner such that at least one gaseous CO₂ capture performance metric of the power plant is improved relative to a suitable control. To this end, power plant 101 includes controller 106. The controller 106 is configured to modulate the flue gas rates of first CO₂ gas point source 102 and a second CO₂ gas point source 103. In the example of FIG. 1, controller 106 has increased the flue gas rate of second CO₂ gas point source 103 relative to the flue gas rate of first CO₂ gas point source 102, as depicted by the relative size of the arrows associated with each CO₂ gas point source.

### Industrial Plants

Aspects of the invention additionally include industrial plants. The subject industrial plants include a plurality of different types of CO₂ gas point source emitters, a common CO₂ capture system operatively coupled to two or more of the different types of CO₂ gas point source emitters, and a controller configured to control the different types of CO₂ gas point source emitters and common CO₂ capture system in a manner such that at least one gaseous CO₂ capture performance metric of the industrial plant is improved relative to a suitable control. The industrial plant described herein may be any plant suitable for carrying out an industrial process. Industrial plants of interest include, but are not limited to cement plants, smelters, refineries and chemical plants. In certain embodiments, the industrial plant is a refinery.

Any suitable number of CO₂ gas point source emitters may be employed in the subject industrial plants. In certain cases, the number of CO₂ gas point source emitters in the plurality of CO₂ gas point source emitters ranges from 2 to 20, such as 2 to 5, and including 2 to 3. In some embodiments, the industrial plant includes 2 (i.e., a first and second) CO₂ gas point source emitters. The different types of CO₂ gas point source emitters may include, but are not limited to, a coker unit, a gas-fired furnace, a fluidized catalytic cracker (FCC), and a hydrogen-generating reformer. A “coker unit” is referred to herein in its conventional sense to describe an oil refinery unit configured to convert residual oil into one or more different products (e.g., hydrocarbon gasses, naphtha, gas oils, coke). In one example, the industrial plant may have multiple point sources of CO₂ emissions for various process steps whereby one stack is emitting CO₂ from a coker unit, another from a gas-fired furnace, another from an FCC, and yet another from a hydrogen-generating reformer.

As discussed above, industrial plants of interest include a common CO₂ capture system operatively coupled to two or more of the different types of CO₂ gas point source emitters. Any suitable common CO₂ capture system may be employed, including, but not limited to, those described above. For example, gaseous CO₂ capture protocols of interest include absorption into a liquid or solid, adsorption, membrane transport and combinations thereof. In some embodiments, the common CO₂ capture system includes a capture liquid that is circulated among the different CO₂ gas point sources. In such embodiments, gaseous CO₂ is extracted by the capture liquid from each CO₂ gas point source. The capture liquid may subsequently be transported to a common location for treatment (i.e., mineralization and/or regeneration, as described above). As such, in certain cases, the common CO₂ capture system comprises a mineralization capture system. In certain embodiments, the mineralization capture system produces a solid carbonate material. The solid carbonate material may, in some cases, include a building material. Building materials of interest include, for example, aggregates, highly reflective microcrystalline or amorphous material compositions and cementitious compositions. In some embodiments, the building materials are formed building materials, including, but not limited to, bricks; boards; conduits; beams; basins; columns; drywalls etc.

Where the common CO₂ capture system includes a capture liquid, said capture liquid may, in some embodiments, be transported from a gaseous CO₂ source having a low partial pressure of CO₂ to a gaseous CO₂ source having a comparatively higher partial pressure of CO₂ (e.g., as discussed above). In one example where there are three different gaseous CO₂ sources (e.g., a coker unit, a gas-fired furnace and a hydrogen-generating reformer), the capture liquid receives CO₂ from the gaseous CO₂ source having the lowest partial pressure of CO₂, transported to the gaseous CO₂ source having the second lowest partial pressure of CO₂, and subsequently transported to the gaseous CO₂ source having the highest partial pressure of CO₂. The stream leaving the highest partial pressure source could then be sent to a mineralization capture system for mineralization of the CO₂ and regeneration of the capture solution. In embodiments, the regenerated capture solution is returned back to the gaseous CO₂ source having the lowest partial pressure of CO₂ such that the carbon sequestration cycle is repeated. In certain cases, the partial pressure of the gaseous CO₂ sources fluctuates, and the controller is configured to shift the circulation of capture liquid such that the liquid is transported from the gaseous CO₂ source having a low partial pressure of CO₂ to a gaseous CO₂ source having a comparatively higher partial pressure of CO₂, whichever gaseous CO₂ sources those may be at a given time.

In other embodiments, the common CO₂ capture system comprises a scrubber system. The scrubber system may, in some instances, include an amine scrubber system. Such systems are described above and involve the removal of acid gases such as CO₂—and, where relevant, hydrogen sulfide (H₂S)—by contacting such gases with an amine solution to form salt complexes. In embodiments of the industrial plants including a scrubber system, the CO₂ gas point sources are a part of the same amine scrubber system. For example, in certain cases, each CO₂ gas point source is associated with an individual contactor column in which the gaseous CO₂ from the CO₂ gas point source is captured such that rich amine is generated. The rich amine from each of the contactor columns may be connected via a series of conduits to a common regenerator column in which lean amine is regenerated and pure gaseous CO₂ is captured. In other cases, each CO₂ gas point source is connected to the same contactor column.

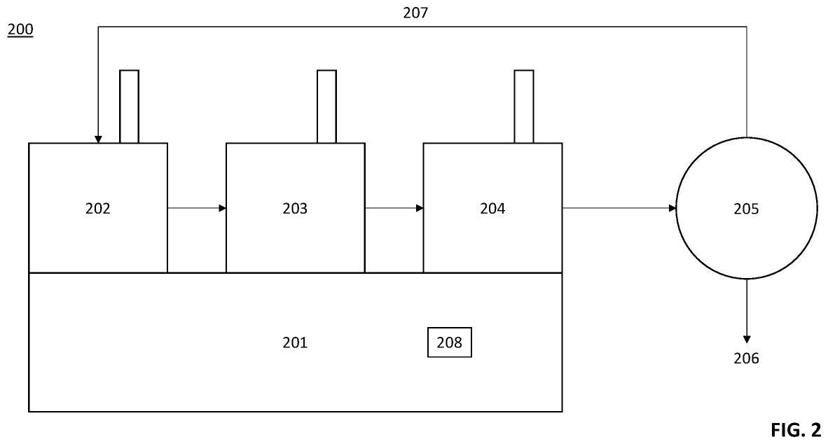

FIG. 2 depicts a gaseous CO₂ capture system 200 including an industrial plant 201 according to certain embodiments of the invention. Industrial plant 201 includes CO₂ gas point source 202, CO₂ gas point source 203 and CO₂ gas point source 204. Each of the CO₂ gas point sources 202-204 are different types of CO₂ gas point source (e.g., a coker unit, a gas-fired furnace and a hydrogen-generating reformer). In the example of FIG. 2, capture liquid first enters CO₂ gas point source 202 (i.e., the CO₂ gas point source having the lowest partial pressure of gaseous CO₂ emitting therefrom). After the capture liquid receives the gaseous CO₂ emitting from CO₂ gas point source 202, it is transferred to CO₂ gas point source 203 (i.e., the CO₂ gas point source having the second lowest partial pressure of gaseous CO₂ emitting therefrom). After the capture liquid receives the gaseous CO₂ emitting from CO₂ gas point source 203, it is transferred to CO₂ gas point source 204 (i.e., the CO₂ gas point source having the highest partial pressure of gaseous CO₂ emitting therefrom). After the capture liquid receives the gaseous CO₂ emitting from CO₂ gas point source 204, it is transferred to mineralization capture system 205 for mineralization of the CO₂ into CO₂ embodied material 206 (e.g., a CO₂ embodied cement, a CO₂ embodied aggregate) and regeneration of the capture liquid. Regenerated capture liquid 207 is subsequently transferred back to CO₂ gas point source 202 to repeat the cycle. In some cases, gaseous CO₂ capture system 200 also includes controller 208 configured to adjust the order in which capture liquid is circulated to CO₂ gas point sources 202-204 in the event that the relative partial pressures of gaseous CO₂ change.

### Co-Located Industrial Plants

Aspects of the invention additionally include a gaseous CO₂ capture system comprising a plurality of co-located industrial plants (including power plants) each comprising a gaseous CO₂ source operatively coupled to one or more mineralization capture sub-systems, a common mineralization capture system feed source and a controller configured to control allocation of the feed source to the one or more mineralization capture sub-systems in a manner such that at least one gaseous CO₂ capture performance metric of the gaseous CO₂ capture system is improved relative to a suitable control. The industrial plants described herein may be any plant suitable for carrying out an industrial process. Industrial plants of interest include, but are not limited to power plants, cement plants, smelters, refineries and chemical plants. Any suitable number of industrial plants may be employed in the subject systems. In certain cases, the number of industrial plants in the plurality of industrial plants ranges from 2 to 10, such as 2 to 5, and including 2 to 3.

Common mineralization capture system feed sources of interest include, for example, aqueous media sources, ammonia sources, as well as alkalinity sources (e.g., as described above). In some embodiments, the feed source comprises alkalinity. In additional embodiments, the feed source comprises metal ion. In certain cases, the feed source comprises an alkaline earth metal cation (e.g., a divalent cation). Divalent cations of interest that may be employed, either alone or in combination, as the divalent cation source include, but are not limited to: Ca²⁺, Mg²⁺, Be²⁺, Ba²⁺, Sr²⁺, Pb²⁺, Fe²⁺, Hg²⁺, and the like. Other cations of interest that may or may not be divalent include, but are not limited to: Na⁺, K⁺, NH⁴⁺, and Li⁺, as well as cationic species of Mn, Ni, Cu, Zn, Cu, Ce, La, Al, Y, Nd, Zr, Gd, Dy, Ti, Th, U, La, Sm, Pr, Co, Cr, Te, Bi, Ge, Ta, As, Nb, W, Mo, V, etc.

The common mineralization capture feed source may be located at any convenient distance from each of the industrial plants. In some embodiments, the distance separating the mineralization capture feed source from any one of the industrial plants ranges from 0.01 km to 500 km, such as 0.1 km to 400 km, such as 0.5 km to 300 km, such as 1 km to 250 km, such as 1.5 km to 200 km, such as 2 km to 150 km, such as 2.5 km to 100 km, such as 3 km to 50 km, and including 4 km to 25 km. Material may be transported from the mineralization capture system feed source to the industrial plants via any convenient protocol, including but not limited to train/rail lines, trucking routes, air routes, pipelines, sea routes and combinations thereof. The common mineralization capture feed source may, in certain cases, be a transportation hub. In such cases, the common location is a point (i.e., hub) within a transportation network at which materials may be received and/or shipped out. Transportation hubs include, but are not limited to, seaports, train/rail stations, airports, warehouses, pipelines, and the like.

In some embodiments, systems additionally include one or more mineralization capture systems (e.g., such as those described above). Any suitable number of mineralization capture systems may be included. For example, in some embodiments, each industrial plant in the plurality of industrial plants includes a mineralization capture system. In certain cases where a particular industrial plant includes multiple gaseous CO₂ sources, each gaseous CO₂ source may be connected to the same mineralization capture system (e.g., as described above and/or depicted in FIG. 2). In another embodiment, each industrial plant is connected to the same mineralization capture system such that mineralization of CO₂ captured from each industrial plant occurs at a common location. In some versions, the common location at which CO₂ captured from each industrial plant is mineralized is co-located with the mineralization capture system feed source. In still other embodiments, each gaseous CO₂ source includes an individual mineralization capture sub-system.

As discussed above, the subject systems include a controller configured to control allocation of the feed source to the one or more mineralization capture sub-systems in a manner such that at least one gaseous CO₂ capture performance metric of the gaseous CO₂ capture system is improved relative to a suitable control. In some cases, the gaseous CO₂ capture performance metric comprises feed source utility efficiency. In other words, the system decreases the amount of feed source material required to capture and/or mineralize the same amount of CO₂ in a system lacking a common mineralization capture system feed source (i.e., a suitable control).

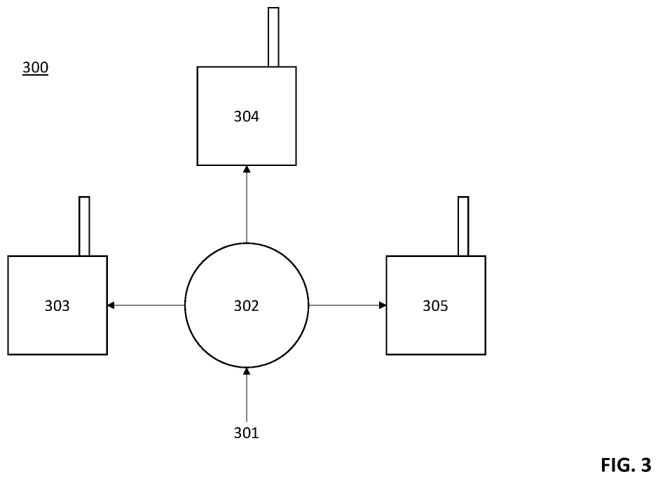

FIG. 3 depicts a gaseous CO₂ capture system 300 according to certain embodiments of the invention. Gaseous CO₂ capture system 300 includes common a common mineralization capture system feed source 302 that receives feed material 301. In the example of FIG. 3, feed material 301 is a source of alkalinity (e.g., divalent cations). In addition, Gaseous CO₂ capture system 300 includes gaseous CO₂ sources 303-304. The type of gaseous CO₂ source employed in gaseous CO₂ sources 303-304 may be the same or different. Mineralization capture system feed source 302 provides the feed material 301 to each of the gaseous CO₂ sources 303-304.

### Common Electrical Grid

Aspects of the invention further include gaseous CO₂ capture systems comprising a plurality of gaseous CO₂ sources each operatively coupled to a CO₂ capture sub-system, a common electrical grid operatively coupled to the plurality of gaseous CO₂ sources, and a controller configured to control power allocation to the plurality of gaseous CO₂ sources from the different types of power sources via the common electrical grid in a manner such that at least one gaseous CO₂ capture performance metric of the gaseous CO₂ capture system is improved relative to a suitable control. Common electrical grids of interest receive power from different types of power sources. By “electrical grid” is meant an electrical network for supplying electrical power to a community of consumers, such as 100 or more, 1,000 or more, or 10,000 or more, residential, commercial, and/or industrial power consuming units. Electrical grids may include, for example, transmission lines, substations (e.g., step-up substations, step-down substations, distribution substations), and the like.

The common electrical grid described herein receives power from multiple different power sources. Power sources of interest are described above and include, for example, renewable power sources, fossil fuel power sources, hydrogen power sources, and combinations thereof. In one example, the common electrical grid receives power from each of a renewable power source, a fossil fuel power source and a hydrogen power source.

In certain cases, the CO₂ capture sub-system coupled to each gaseous CO₂ source is a mineralization capture system. In other words, each of the CO₂ capture sub-system is operably connected to a mineralization capture system for mineralization of captured CO₂ into CO₂ embodied material. In certain cases where a particular CO₂ capture sub-system is associated with multiple gaseous CO₂ sources, each gaseous CO₂ source may be connected to the same mineralization capture system (e.g., as described above and depicted in FIG. 2). In an additional embodiment, each CO₂ capture sub-system is connected to the same mineralization capture system such that mineralization of CO₂ captured from each industrial plant occurs at a common location.

As discussed above, the gaseous CO₂ capture system includes a controller configured to control power allocation to the plurality of gaseous CO₂ sources from the different types of power sources via the common electrical grid in a manner such that at least one gaseous CO₂ capture performance metric of the gaseous CO₂ capture system is improved relative to a suitable control. In some embodiments, the gaseous CO₂ capture performance metric comprises power usage efficiency. For example, the controller may cause the acquisition of less expensive and more sustainable power relative to a comparable system that does not have such a controller (i.e., a suitable control).

In some cases, the controller controls power allocation based on one or more of: power cost, fraction of renewable power generation, power transportation cost, and combinations thereof. In some instances, the controller controls power allocation based on power cost. In instances where the cost of power varies when it is obtained from different power sources, the controller may be configured to allocate power to the plurality of gaseous CO₂ sources and/or CO₂ capture sub-systems such that a higher proportion of power from a less expensive source is obtained. In other instances, the controller controls power allocation based on the fraction of renewable power generation. In versions where the power sources that supply power to the common electrical grid differ according to renewability, the controller may be configured to allocate power to the plurality of gaseous CO₂ sources and/or CO₂ capture sub-systems such that a higher proportion of power from a more renewable source is obtained. In still other embodiments, the controller controls power allocation based on power transportation cost. For example, in some cases, power may cost more to transport via one transmission route (e.g., over one or more transmission lines) as compared to another transmission route. In such a case, the controller may be configured to adjust the power source and/or the transmission route over which the electricity is conveyed from the power source to the gaseous CO₂ sources and/or CO₂ capture sub-systems such that power transportation cost is minimized. In certain cases, using the most renewable power (for example hydroelectricity or solar) to capture CO₂ from a local point source emitter may not be as optimal as using another source of power (such as a power plant operating on “Blue Hydrogen” with 80% capture efficiency) if the overall availability of the renewable power is not as good. In that case, the use of service factor or up-time of the various power sources of the common grid would be considered by the controller.

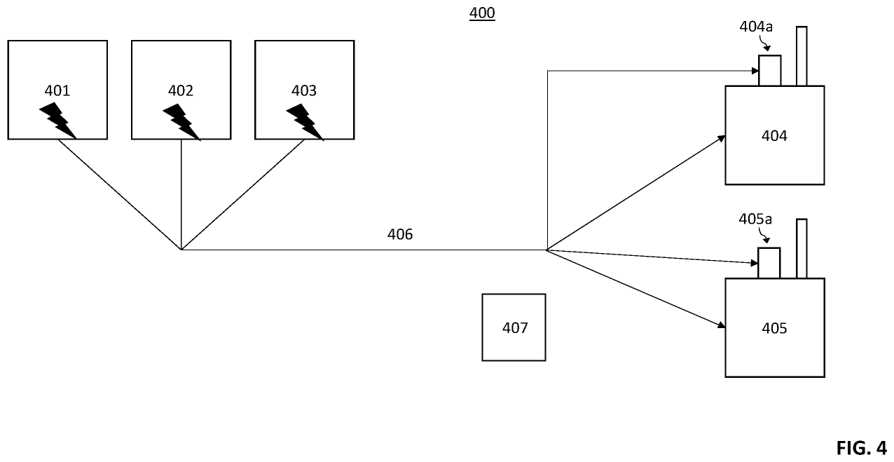

FIG. 4 depicts a gaseous CO₂ capture system 400 including a plurality of gaseous CO₂ sources 404-405 and a common electrical grid 406 operatively coupled to the plurality of gaseous CO₂ sources 404-405 according to certain embodiments. Power sources 401-403 provide power to common electrical grid 406. The common electrical grid 406 is a simplified version of an electrical grid. In reality, electrical grids include a more convoluted web of connected elements. In the example of FIG. 4, each of power sources 401-403 are different types of power source. Power source 401 is a renewable power source, power source 402 is a fossil fuel power source and power source 403 is a hydrogen power source. Controller 407 allocates power (including different amount of power) from power sources 401-403 to each gaseous CO₂ source 404-405 based on one or more of: power cost, fraction of renewable power generation, power transportation cost, and combinations thereof, as discussed above. In addition, gaseous CO₂ source 404 includes amine scrubber system 404a, and gaseous CO₂ source 405 includes amine scrubber system 405a. Amine scrubbers 404a and 405a also receive an amount power from common electrical grid 406 produced by power sources 401-403 that is determined by controller 407.

In some embodiments, controller 407 changes the allocation of power from power sources 401-403 to gaseous CO₂ sources 404-405 over time. For example, controller 407 may allocate more total power to gaseous CO₂ sources 404-405 when the fraction of renewable power generation is high and may allocate less total power when the fraction of renewable power generation is low.

### Related Disposition Usage

Aspects of the invention additionally include a gaseous CO₂ capture system having first and second gaseous CO₂ sources and CO₂ capture sub-systems that produce first and second mineralized feed building materials from gaseous CO₂. Systems of interest additionally include a common building material producer that prepares a building material from the first and second mineralized feed building materials, as well as a controller configured to control production of the first and second mineralized feed building materials in a manner such that at least one gaseous CO₂ capture performance metric of the gaseous CO₂ capture system is improved relative to a suitable control.

Any convenient gaseous CO₂ source may be employed in the subject gaseous CO₂ capture system. As discussed in detail above, gaseous CO₂ sources include CO₂ gas point source emitters (e.g., power plants, cement plants, smelters, refineries and chemical plants) and CO₂ gas direct air capture (DAC) sources. The first and second gaseous CO₂ sources may either be the same or different. In one example, the both the first and second gaseous CO₂ sources are point source emitters, such as where the first and second gaseous CO₂ sources are refineries. In another example, the first gaseous CO₂ source is a CO₂ gas point source emitter and the second gaseous CO₂ source is a CO₂ gas direct air capture (DAC) source, and so on.

The first and second CO₂ capture sub-systems may be any CO₂ capture sub-system that is configured to produce mineralized feed building material from gaseous CO₂. For example, the first and second CO₂ capture sub-systems may employ a gaseous CO₂ capture protocol selected from the group consisting of absorption into a liquid or solid, adsorption, membrane transport and combinations thereof (e.g., as discussed in detail above). The gaseous CO₂ capture protocol employed by the first and second CO₂ capture sub-systems may be the same or different. In one example, both the first and second CO₂ capture sub-systems employ a gaseous CO₂ capture protocol comprising absorption into a liquid (e.g., a capture liquid). In another embodiments, the first CO₂ capture sub-system employs a gaseous CO₂ capture protocol comprising absorption into a liquid, while the second CO₂ capture sub-system employs a gaseous CO₂ capture protocol comprising membrane transport, and so on.

As discussed above, the first CO₂ capture sub-system produces a first mineralized feed building material from gaseous CO₂, and the second CO₂ capture sub-system produces a second mineralized feed building material from gaseous CO₂. The first and second mineralized feed building materials may be any convenient building material containing embodied CO₂. In some embodiments, the first and/or second mineralized building material is a formed building material (e.g., bricks; boards; conduits; beams; basins; columns; drywalls etc.). In other embodiments, the first and/or second mineralized building material is a microcrystalline or amorphous material composition effective to enhance the albedo of the surface. In still other embodiments, the first mineralized feed building material comprises a cement, and the second mineralized feed building material comprises an aggregate.

Aspects of the present systems also include a common building material producer that prepares a building material from the first and second mineralized feed building materials. For example, where the first mineralized feed building material comprises a cement and the second mineralized feed building material comprises an aggregate, the building material prepared by the common building material producer may be a concrete. In such cases, the common building material producer combines the cement and aggregate such that concrete is produced.

Embodiments of the present systems further include a controller configured to control production of the first and second mineralized feed building materials in a manner such that at least one gaseous CO₂ capture performance metric of the gaseous CO₂ capture system is improved relative to a suitable control. In certain instances, the gaseous CO₂ capture performance metric comprises usage efficiency of first and second mineralized feed building materials. In some instances, the controller is configured to optimize the fraction of gaseous CO₂ capture conducted in each of the first and second gaseous CO₂ capture subsystems to align with the needs of the common building material producer. For example, if the common building material producer employs 50× the amount of aggregate as it does cement, the CO₂ capture technologies might be allotted so as to produce 50× the aggregate as cement to align with the downstream needs. In some cases, the controller is programmed to adjust the rate at which the common building material producer prepares the building material (e.g., concrete) based on the availability of the first and second mineralized feed building materials.

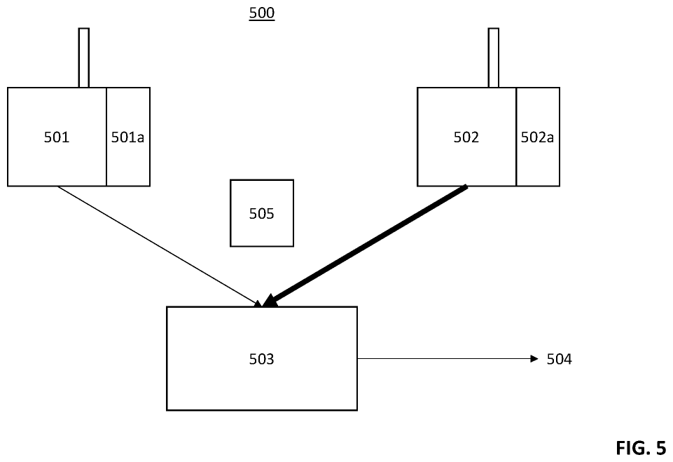

FIG. 5 depicts a gaseous CO₂ capture system having first and second gaseous CO₂ sources and CO₂ capture sub-systems that produce first and second mineralized feed building materials from gaseous CO₂. First gaseous CO₂ source 501 is associated with first gaseous CO₂ capture sub-system 501a, and second gaseous CO₂ source 502 is associated with second gaseous CO₂ capture sub-system 502a. In the example of FIG. 5, first gaseous CO₂ capture sub-system 501a is configured to produce cement from gaseous CO₂ captured at first gaseous CO₂ source 501. In addition, second gaseous CO₂ capture sub-system 502a is configured to produce aggregate from gaseous CO₂ captured at second gaseous CO₂ source 502. The resulting mineralized feed building materials (i.e., cement and aggregate) are subsequently transported to common building material producer 503. In this example, common building material producer 503 is configured to produce concrete 504 by combining the mineralized feed building materials. Controller 505 is configured to control production of the first and second mineralized feed building materials to, e.g., maximize usage efficiency of first and second mineralized feed building materials. As depicted by the greater thickness of the arrow denoting the transfer of mineralized feed building material to the common building material producer 503, controller 505 may induce second gaseous CO₂ capture sub-system 502a to produce more of the second mineralized feed building material relative to the first.

### Bicarbonate Rich Aqueous Solution-Based Capture Systems

Aspects of the invention also include bicarbonate rich aqueous solution-based capture systems. The bicarbonate rich aqueous solution-based capture systems are systems in which the common CO₂ capture constraining element is a capture liquid that becomes a bicarbonate rich aqueous solution when contacted with CO₂. Systems of the invention include at least one gaseous CO₂ source, a CO₂ capture system configured to contact CO₂ from the gaseous CO₂ source with capture liquid, an outgoing capture liquid pipeline configured to supply capture liquid to the CO₂ capture system, a bicarbonate rich aqueous solution return pipeline configured to convey bicarbonate rich aqueous solution produced at the CO₂ capture system, and a mineralization system configured to generate a solid carbonate product from the bicarbonate rich aqueous solution and thereby regenerate the capture liquid. Where desired, such systems may also include an alkaline enrichment system, e.g., that restores alkalinity to the solution, positioned between the capture and mineralization systems, e.g., co-located with the capture system, co-located with the mineralization system, or positioned between the capture and mineralization systems. For example, a given system could include an alkalinity enrichment system that contacts the solution leaving the mineralization system with a source of alkalinity, e.g., geomass, so as to increase alkalinity of the solution, which is then conveyed back to the capture system. Alkalinity enrichment systems that may be components of embodiments of the invention include those described in U.S. patent application Ser. No. 17/261,678 published as 20210262320; the disclosure of which is herein incorporated by reference. Systems according to some such embodiments of the invention are not configured to convey liquified CO₂, and therefore do not include coolers or condensers configured to produce and/or convey liquified CO₂. The at least one gaseous CO₂ source can be any suitable gaseous CO₂ source, such as those described above. Similarly, the mineralization capture system may be configured to produce the solid carbonate via any suitable mechanism described herein. Systems may also include one or more pumps configured to drive capture liquid through the pipelines.

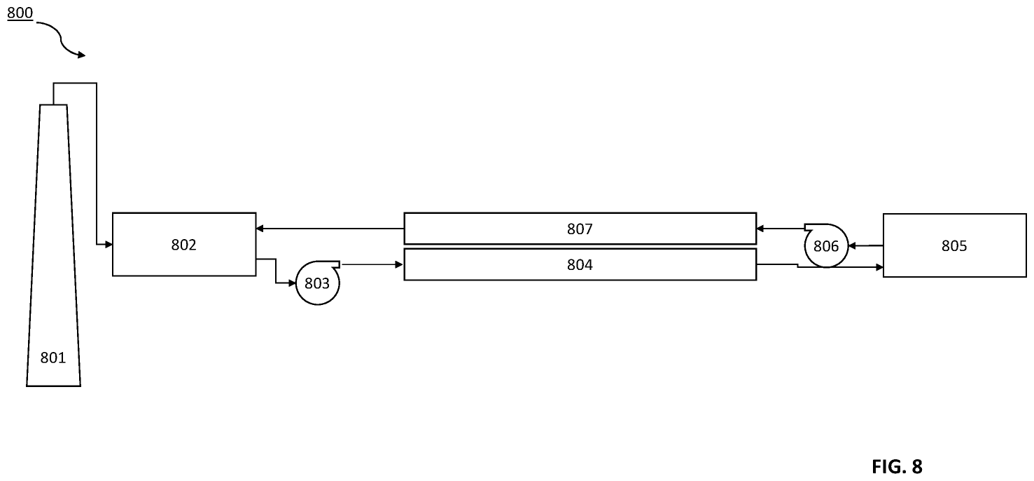

FIG. 8 presents a bicarbonate rich aqueous solution-based capture system 800 including an industrial plant 801 that uses a CO₂ capture system 802 to produce a bicarbonate rich aqueous solution which is provided to a mineralization capture system 805, according to certain embodiments. The bicarbonate rich aqueous solution capture system 800 includes a pump 803 configured to transport the bicarbonate rich aqueous solution through bicarbonate rich aqueous solution return pipeline 804 which provides the solution to mineralization capture system 805. After the bicarbonate rich aqueous solution has been used in mineralization capture system 805 to produce a solid carbonate, as illustrated, capture liquid is returned to CO₂ capture system 802 as a carbon-depleted aqueous solution, i.e., an aqueous ammonia capture liquid, e.g., a 2.5 M ammonium hydroxide solution, using a pump 806. The carbon-depleted aqueous solution is transported through outgoing capture liquid pipeline 807. The length of pipelines 807 and 804 may vary as desired, ranging in some instances from 0.01 km to 200 km, such as 0.01 km to 20 km and including 0.1 km to 5 km. The pipelines may be configured to convey an aqueous composition at room temperature and pressure, where the temperature of the liquid conveyed in the pipelines may range from −0.3° C. to 100° C., such as 10° C. to 50° C. and the pressure may range from 0.1 psia to 500 psig, such as 14 psia to 100 psig. The pipelines may be constructed of any convenient material, where materials of interest include, but are not limited to PVC, CPVC, fiber reinforced plastic (FRP) including glass fiber reinforced epoxy (GRE) and glass reinforced polymer (GRP), concrete pipe, stainless steel, Polyethylene (PE), polyamide plastics, Titanium alloy, combinations thereof, and the like. The dimensions of the pipelines may also vary as desired, where in some instances the pipelines have an outer diameter ranging from 2″ to 72″, such as 12″ to 60″ and a wall thickness ranging from 1/32″ to 1″. In a given system, the pipelines may be above and/or below ground along their length, as desired.

Aspects of the invention additionally include a common mineralization capture system in which multiple gaseous CO₂ sources are included. Any suitable number of CO₂ gas point source emitters may be employed in the subject common mineralization capture systems. In certain cases, the number of CO₂ gas point source emitters in the plurality of CO₂ gas point source emitters ranges from 2 to 20, such as 2 to 5, and including 2 to 3. The different types of CO₂ gas point source emitters may include, but are not limited to, a coker unit, a gas-fired furnace, a coal-fired furnace, a fluidized catalytic cracker (FCC), and a hydrogen-generating reactor. In select cases, the CO₂ gas point source emitters are parts of different industrial processes that are spatially separated. In other words, in contrast to the embodiment of the invention discussed above with respect to FIG. 2 in which the CO₂ gas point source emitters are part of the same industrial plant, the invention also includes embodiments in which multiple industrial plants and/or power plants having different (though potentially related) functions are separated from each other by a distance but are associated with each other via a common CO₂ capture constraining element constituted by a capture liquid in a bicarbonate rich aqueous solution-based capture system. Each industrial plant in the plurality of industrial plants and/or power plants may vary, and can include, but is not limited to a cement plant, a smelter (e.g., nickel smelter), a refinery, a fertilizer plant, a plastics factory, a steel production plant and a chemical plant (e.g., a hydrogen gas production facility). In some cases where multiple industrial plants are included, the industrial plants have related functions. Put another way, the output of one industrial plant may serve as an input for another industrial plant, or vice versa.

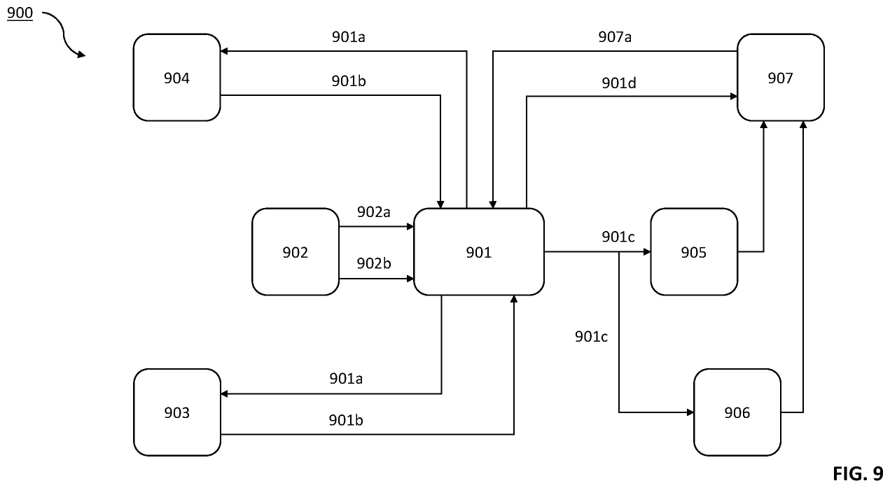

FIG. 9 depicts a bicarbonate rich aqueous solution-based capture system 900 which includes a common mineralization capture system 901, e.g., a mineralization hub, according to certain embodiments. The common mineralization capture system 901 receives three types of inputs: (i) a gaseous source of CO₂ 902a from one type of CO₂ point source emitter, e.g., a steel making facility 902, (ii) geomass 902b from one type geomass producing facility, e.g., steel making facility 902, and geomass 907a from a second type of geomass production facility, e.g., waste from the demolition of carbon-reducing buildings 907, and (iii) bicarbonate rich aqueous solution 901b from a second type of CO₂ point source emitter, e.g., a hydrogen (H₂) production facility 903, and from a third type of CO₂ point source emitter, e.g., a natural gas combined cycle plant 904. In FIG. 9, common CO₂ mineralization system 901 uses the above-mentioned inputs to produce three effluent streams: (i) a solid CO₂-sequestered material 901c, e.g., calcium carbonate (CaCO₃) aggregate for use in, e.g., ready-mix concrete 905 and precast concrete 906, (ii) an upcycled geomass 901d, e.g., upcycled concrete aggregate (UCA) for use in, e.g., the construction of carbon-reducing buildings 907, and (iii) a carbon-depleted aqueous solution 901a, i.e., an aqueous ammonia capture liquid, e.g., a 2.5 M ammonium hydroxide solution, for removal of CO₂ from one type of CO₂ point source emitter, e.g., a H₂ production facility 903, and from a second type of CO₂ point source emitter, e.g., a natural gas combined cycle plant 904. FIG. 9 also considers the construction of carbon-reducing buildings 907 with ready-mix concrete 905, prepared with a solid CO₂-sequestered material 901c, and with precast concrete 906, prepared with a solid CO₂-sequestered material 901c.

Aspects of the invention include methods of transporting CO₂ from a first location to a second location distant to the first location. While the distance between the locations may vary, in some instances the distance ranges from 0.01 km to 200 km, such as 0.01 km to 20 km and including 0.1 km to 5.0 km. In embodiments, the method includes capturing the CO₂, e.g., from a gaseous source, e.g., as described above, with a capture liquid, such as an aqueous capture liquid (such as described above), to produce a bicarbonate rich aqueous solution. Following production of the bicarbonate rich aqueous solution, the bicarbonate rich aqueous solution is then transported from the first location to the second location. In some instances, transport is via a pipeline, e.g., as described above. The aqueous composition may be conveyed from the first location to the second location at room temperature and pressure, where the temperature of the liquid conveyed in the pipelines may range from −0.3° C. to 200° C., such as −0.3 to 100° C. and the pressure may range from 0.1 psia to 500 psig, such as 14 psia to 100 psig. In some instances, the second location is a mineralization capture system, e.g., as described above. In this manner, CO₂ is transported from the first location to the second location. Relative to transport of liquefied CO₂, transport of CO₂ in accordance with the present invention uses less energy (e.g., since the bicarbonate rich aqueous solution is less energy intensive to produce, and does not have to be pressurized or chilled for transportation), where the reduction in energy use in embodiments is 40× or more, such as 10× or more.

### Methods

Aspects of the invention additionally include methods for practicing the subject invention. Methods of interest include configuring and/or operating a plurality of gaseous CO₂ sources and at least one common CO₂ capture constraining element shared by the plurality of CO₂ sources such that at least one gaseous CO₂ capture performance metric of the system is improved relative to a suitable control.

Any convenient number and type of gaseous CO₂ sources may be employed. As discussed in detail above, gaseous CO₂ sources include gas point source emitters (e.g., power plants, cement plants, smelters, refineries and chemical plants) and CO₂ gas direct air capture (DAC) sources. In addition, any suitable common CO₂ capture constraining element may be employed. As discussed in detail above, exemplary CO₂ capture constraining elements include capture liquid, proximity to a common location, access to a common transportation chain, mineralized product distribution center, power usage from a common grid, or a combination thereof. In some embodiments, the gaseous CO₂ performance metric is the amount of CO₂ captured by the system. In other embodiments, the gaseous CO₂ capture performance metric is CO₂ capture efficiency. In still other embodiments, the gaseous CO₂ capture performance metric includes power usage efficiency. In yet other embodiments, gaseous CO₂ capture performance metric comprises usage efficiency of the captured CO₂ (e.g., as mineralized feed building materials).

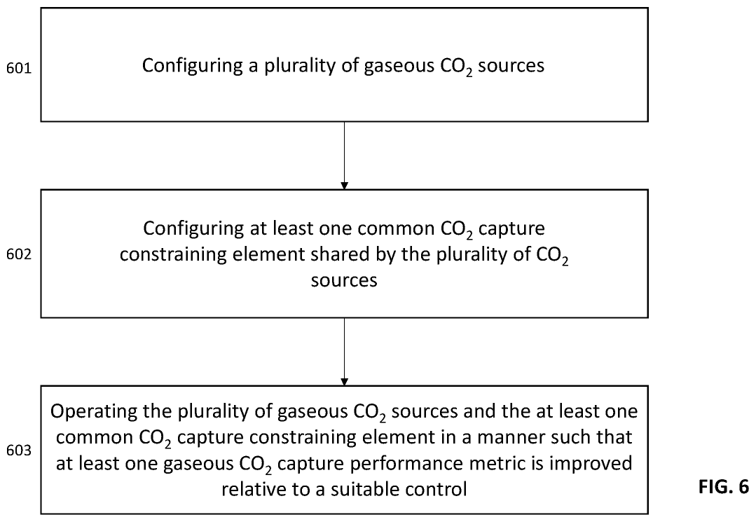

FIG. 6 presents a flowchart for practicing methods according to embodiments of the subject invention. Step 601 includes configuring a plurality of gaseous CO₂ sources, and step 602 includes configuring at least one common CO₂ capture constraining element shared by the plurality of CO₂ sources. In the embodiment of FIG. 6, the gaseous CO₂ sources are configured (step 601) prior to the common CO₂ capture constraining element (step 602). However, in other embodiments, the common CO₂ capture constraining element (step 602) is configured prior to the gaseous CO₂ sources (step 601). The method additionally includes operating the plurality of gaseous CO₂ sources and the at least one common CO₂ capture constraining element in a manner such that at least one gaseous CO₂ capture performance metric is improved relative to a suitable control (step 603).

### Utility

Systems and methods of the instant disclosure find use where it is desirable to improve a gaseous CO₂ capture performance metric associated with carbon capture. For example, the invention may be employed to increase: the amount of CO₂ captured by the system, the efficiency with which CO₂ is captured, the efficiency with which a feed source (e.g., alkalinity source) is used, power usage efficiency, and the usage efficiency of first and second mineralized feed building materials (e.g., cement and aggregate).

The subject solid, e.g., aggregate, compositions and settable compositions that include the same, find use in a variety of different applications, such as above ground stable CO₂ sequestration products, as well as building or construction materials. Specific structures in which the settable compositions of the invention find use include, but are not limited to: pavements, architectural structures, e.g., buildings, foundations, motorways/roads, overpasses, bridges, parking structures, brick/block walls and footings for gates, fences and poles. Mortars of the invention find use in binding construction blocks, e.g., bricks, together and filling gaps between construction blocks. Mortars can also be used to fix existing structure, e.g., to replace sections where the original mortar has become compromised or eroded, among other uses.

Notwithstanding the appended claims, the disclosure is also defined by the following clauses:

1. A gaseous CO₂ capture system, the system comprising:

a plurality of gaseous CO₂ sources; and

at least one common CO₂ capture constraining element shared by the plurality of CO₂ sources;

wherein at least one gaseous CO₂ capture performance metric of the system is improved relative to a suitable control.

2. The gaseous CO₂ capture system according to Clause 1, wherein the plurality of gaseous CO₂ sources comprises gaseous CO₂ sources selected from the group consisting of CO₂ gas point source emitters and CO₂ gas direct air capture (DAC) sources.
3. The gaseous CO₂ capture system according to Clause 2, wherein the plurality of gaseous CO₂ sources comprises CO₂ gas point source emitters.
4. The gaseous CO₂ capture system according to Clause 2, wherein the plurality of gaseous CO₂ sources comprises CO₂ gas DAC sources.
5. The gaseous CO₂ capture system according to Clause 1, wherein the plurality of gaseous CO₂ sources comprises both CO₂ gas point source emitters and CO₂ gas DAC sources.
6. The gaseous CO₂ capture system according to any of Clauses 2 to 5, wherein the CO₂ gas point emitters are selected from the group consisting of power plants, cement plants, smelters, refineries and chemical plants.
7. The gaseous CO₂ capture system according to any of the preceding clauses, wherein the common CO₂ capture constraining element is selected from the group consisting of CO₂ capture liquid, proximity to a common location, access to a common transportation chain, mineralized product distribution center, power usage from a common grid, or a combination thereof.
8. The gaseous CO₂ capture system according to any of the preceding clauses, wherein the gaseous CO₂ capture system employs a gaseous CO₂ capture protocol selected from the group consisting of absorption into a liquid or solid, adsorption, membrane transport and combinations thereof.
9. The gaseous CO₂ capture system according to any of the preceding clauses, wherein the gaseous CO₂ capture system employs a gaseous CO₂ capture protocol that provides for a gaseous CO₂ disposition selected from the group consisting of mineralization, geologic sequestration, chemical conversion, electrochemical conversion and combinations thereof.
10. The gaseous CO₂ capture system according to any of the preceding clauses, wherein the gaseous CO₂ capture system employs a gaseous CO₂ capture protocol that removes one or more additional pollutants from at least one gaseous CO₂ source of the plurality of gaseous CO₂ sources.
11. A power plant comprising:

first and second CO₂ gas point source emitters;

a common CO₂ capture system operatively coupled to each of the first and second CO₂ gas point source emitters; and

a controller configured to control the first and second CO₂ gas point source emitters and common CO₂ capture system in a manner such that at least one gaseous CO₂ capture performance metric of the power plant is improved relative to a suitable control.

12. The power plant according to Clause 11, wherein the first and second CO₂ gas point source emitters are flue-gas stacks.
13. The power plant according to Clause 12, wherein the controller is configured to modulate flue gas rates in each of the flue-gas stacks.
14. The power plant according to any of Clauses 11 to 13, wherein the common CO₂ capture system comprises a scrubber system.
15. The power plant according to Clause 14, wherein the scrubber system comprises an amine scrubber system.
16. The power plant according to any of Clauses 11 to 13, wherein the common CO₂ capture system comprises a mineralization capture system.
17. The power plant according to Clause 16, wherein the mineralization capture system produces a solid carbonate material.
18. The power plant according to Clause 17, wherein the solid carbonate material comprises a building material.
19. The power plant according to Clause 18, wherein the building material comprises an aggregate.
20. The power plant according to any of Clauses 11 to 16, wherein the gaseous CO₂ capture performance metric is amount of captured CO₂.
21. An industrial plant comprising:

a plurality of different types of CO₂ gas point source emitters;

a common CO₂ capture system operatively coupled to each of the different types of CO₂ gas point source emitters; and

a controller configured to control the different types of CO₂ gas point source emitters and common CO₂ capture system in a manner such that at least one gaseous CO₂ capture performance metric of the industrial plant is improved relative to a suitable control.

22. The industrial plant according to Clause 21, wherein the industrial plant is a refinery or cement plant.
23. The industrial plant according to Clause 22, wherein the different types of CO₂ gas point source emitters are selected from the group consisting of a coker unit, a gas-fired furnace and a hydrogen-generating reformer.
24. The industrial plant according to any of Clauses 21 to 23, wherein the common CO₂ capture system comprises a scrubber system.
25. The industrial plant according to Clause 24, wherein the scrubber system comprises an amine scrubber system.
26. The industrial plant according to any of Clauses 21 to 23, wherein the common CO₂ capture system comprises a mineralization capture system.
27. The industrial plant according to Clause 26, wherein the mineralization capture system produces a solid carbonate material.
28. The industrial plant according to Clause 27, wherein the solid carbonate material comprises a building material.
29. The industrial plant according to Clause 28, wherein the building material comprises an aggregate.
30. The industrial plant according to any of Clauses 21 to 29, wherein the gaseous CO₂ capture performance metric is CO₂ capture efficiency.
31. A gaseous CO₂ capture system, the system comprising:

a plurality of co-located industrial plants each comprising a gaseous CO₂ source operatively coupled to one or more mineralization capture sub-systems;

a common mineralization capture system feed source; and

a controller configured to control allocation of the feed source to the one or more mineralization capture sub-systems in a manner such that at least one gaseous CO₂ capture performance metric of the gaseous CO₂ capture system is improved relative to a suitable control.

32. The gaseous CO₂ capture system according to Clause 31, wherein the feed source comprises alkalinity.
33. The gaseous CO₂ capture system according to Clause 31, wherein the feed source comprises metal ion.
34. The gaseous CO₂ capture system according to Clause 33, wherein the metal ion comprises alkaline earth metal cation.
35. The gaseous CO₂ capture system according to any of Clauses 31 to 34, wherein the gaseous CO₂ capture performance metric comprises feed source utility efficiency.
36. A gaseous CO₂ capture system, the system comprising:

a plurality of gaseous CO₂ sources each operatively coupled to a CO₂ capture sub-system;

a common electrical grid operatively coupled to the plurality of gaseous CO₂ sources, wherein the common electrical grid receives power from different types of power sources; and

a controller configured to control power allocation to the plurality of gaseous CO₂ sources from the different types of power sources via the common electrical grid in a manner such that at least one gaseous CO₂ capture performance metric of the gaseous CO₂ capture system is improved relative to a suitable control.

37. The gaseous CO₂ capture system according to Clause 36, wherein the different types of power sources are selected from the group consisting of renewable power sources, fossil fuel power sources, hydrogen power sources, and combinations thereof.
38. The gaseous CO₂ capture system according to Clauses 36 and 37, wherein the controller controls power allocation based on one or more of: power cost, fraction of renewable power generation, power transportation cost, and combinations thereof.
39. The gaseous CO₂ capture system according to any of Clauses 36 to 38, wherein the CO₂ capture sub-system coupled to each gaseous CO₂ source is a mineralization capture system.
40. The gaseous CO₂ capture system according to any of Clauses 36 to 39, wherein the gaseous CO₂ capture performance metric comprises power usage efficiency.
41. A gaseous CO₂ capture system, the system comprising:

a first gaseous CO₂ source operatively coupled to a first CO₂ capture sub-system that produces a first mineralized feed building material from gaseous CO₂;

a second gaseous CO₂ source operatively coupled to a second CO₂ capture sub-system that produces a second mineralized feed building material from gaseous CO₂;

a common building material producer that prepares a building material from the first and second mineralized feed building materials; and

a controller configured to control production of the first and second mineralized feed building materials in a manner such that at least one gaseous CO₂ capture performance metric of the gaseous CO₂ capture system is improved relative to a suitable control.

42. The gaseous CO₂ capture system according to Clause 41, wherein the first mineralized feed building material comprises a cement.
43. The gaseous CO₂ capture system according to Clauses 41 and 42, wherein the second mineralized feed building material comprises an aggregate.
44. The gaseous CO₂ capture system according to any of Clauses 41 to 43, wherein the building material comprises a concrete.
45. The gaseous CO₂ capture system according to any of Clauses 41 to 44, wherein the gaseous CO₂ capture performance metric comprises usage efficiency of first and second mineralized feed building materials.
46. A method of producing a gaseous CO₂ capture system, the method comprising:

configuring:
a plurality of gaseous CO₂ sources; and
at least one common CO₂ capture constraining element shared by the plurality of CO₂ sources;

such that at least one gaseous CO₂ capture performance metric of the system is improved relative to a suitable control.

47. A method of capturing gaseous CO₂, the method comprising:

operating:
a plurality of gaseous CO₂ sources; and
at least one common CO₂ capture constraining element shared by the plurality of CO₂ sources;

in a manner such that at least one gaseous CO₂ capture performance metric is improved relative to a suitable control.

The following is offered by way of example and not by way of limitation:

### EXPERIMENTAL

Table 1 tabulates a comparison of transporting pure CO₂ for liquefaction and subsurface storage 705 from a conventional CCS system 702, like that depicted in FIG. 7, to transporting a bicarbonate rich aqueous solution for a mineralization capture system 805, like that depicted in FIG. 8. The comparison focuses on the characteristics of the pipeline used to transport either liquid CO₂ (FIG. 7) or a bicarbonate rich aqueous solution (FIG. 8). The basis for the comparison considers transporting 175,000 tonnes CO₂ per annum over a pipeline length of 100 km. The mass flow rate of liquid being moved through each pipeline, in units of kg/h, is 20,744 through pipeline 704 versus 242,000 through pipelines 804 and 807, going to and coming from a mineralization capture system 805, respectively. The pipe diameter is 6 inches for the pipeline 704 depicted in FIG. 7, while the pipe diameter is 20 inches for the pipelines 804 and 807 depicted in FIG. 8. The pipeline pressure is 100 bar and 5 bar for configuration 700 and for embodiment 800, respectively; the 20× difference is especially noteworthy as a bicarbonate rich aqueous solution and a carbon-depleted aqueous solution do not require high pressure to maintain their liquid state. The pressure drop across the pipelines, in units of bar, is also in favor of moving CO₂ as a bicarbonate rich solution (FIG. 8, 2 bar) instead of as liquified CO₂ (FIG. 7, 7 bar). Finally, there is a remarkable difference in the power required to move equal quantities of CO₂ in the two scenarios. With an equivalent basis of moving 175,000 tonnes CO₂ per annum through a 100 km pipeline, transporting pure CO₂ for liquefaction and subsurface storage 705 from a conventional CCS system 702 requires 2,096 kW of power, which equates to a roughly 4% parasitic load, assuming plant 701 is a natural gas combined cycle (NGCC) plant. Conversely, with the same basis, transporting a bicarbonate rich aqueous solution for a common CO₂ mineralization system 805 requires only 50 kW of power, which equates to a roughly 0.1% parasitic load, assuming plant 801 is also an NGCC plant.

TABLE 1
Efficiency comparison of the embodiments of FIG. 7 and FIG. 8

| | |
|---|---|
| Known Configuration 700 | Embodiment 800 |

Basis

| | | |
|---|---|---|
| Flow Rate CO, (MTA¹) | 175,000 | 175,000 |
| Pipe Length (km) | 100 | 100 |

Pipeline Data

| | | |
|---|---|---|
| Flow Rate (kg/h) | 20,774 | 242,000 |
| Pipe Diameter (in.) | 6 | 20 |
| Pipeline Pressure (bar) | 100 | 5 |
| Pressure Drop (bar) | 7 | 2 |
| Power Required (kW) | 2,096 | 50 |
| (2) | 4% | 0.1% |
| Parasitic Load | | |

¹ Million tonnes COaper annum
² Transport load only based on CO2 sourced from natural gas combined cycle (NGCC)
plant

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A gaseous CO₂ capture system for capturing CO₂ emitted by a plurality of gaseous CO₂ sources, the system comprising:
at least one common CO₂ capture constraining element shared by the plurality of CO₂ sources;
wherein at least one gaseous CO₂ capture performance metric of the system is improved relative to a suitable control.

2. The gaseous CO₂ capture system according to claim 1, wherein the plurality of gaseous CO₂ sources comprises gaseous CO₂ sources selected from the group consisting of CO₂ gas point source emitters and CO₂ gas direct air capture (DAC) sources.

3. The gaseous CO₂ capture system according to claim 2, wherein the plurality of gaseous CO₂ sources comprises CO₂ gas point source emitters.

4. The gaseous CO₂ capture system according to claim 2, wherein the plurality of gaseous CO₂ sources comprises CO₂ gas DAC sources.

5. The gaseous CO₂ capture system according to claim 1, wherein the plurality of gaseous CO₂ sources comprises both CO₂ gas point source emitters and CO₂ gas DAC sources.

6. The gaseous CO₂ capture system according to claim 1, wherein the common CO₂ capture constraining element is selected from the group consisting of CO₂ capture liquid, proximity to a common location, access to a common transportation chain, mineralized product distribution center, power usage from a common grid, or a combination thereof.

7. The gaseous CO₂ capture system according to claim 6, wherein the common CO₂ capture constraining element is a capture liquid, and the gaseous CO₂ capture system is configured to contact the capture liquid with CO₂ from the plurality of gaseous CO₂ sources such that a bicarbonate rich aqueous solution is generated.

8. The gaseous CO₂ capture system according to claim 1, wherein the gaseous CO₂ capture system employs a gaseous CO₂ capture protocol selected from the group consisting of absorption into a liquid or solid, adsorption, membrane transport and combinations thereof.

9. The gaseous CO₂ capture system according to claim 1, wherein the gaseous CO₂ capture system employs a gaseous CO₂ capture protocol that provides for a gaseous CO₂ disposition selected from the group consisting of mineralization, geologic sequestration, chemical conversion, electrochemical conversion and combinations thereof.

10. The gaseous CO₂ capture system according to claim 1, wherein the gaseous CO₂ capture system employs a gaseous CO₂ capture protocol that removes one or more additional pollutants from at least one gaseous CO₂ source of the plurality of gaseous CO₂ sources.

11-26. (canceled)

27. A method of transporting CO₂ from a first location to a second location distant to the first location, the method comprising:
capturing the CO₂ at the first location with a capture liquid to produce a bicarbonate rich aqueous solution; and
transporting the bicarbonate rich aqueous solution to the second location;
to transport the CO₂ from the first location to the second location.

28. The method according to claim 27, wherein the second location comprises a mineralization system.

29. The method according to claim 27, wherein the distance between the first location and second location ranges from 0.01 km to 200 km.

30. The method according to any of claim 27, wherein the bicarbonate rich aqueous solution is transported from the first location to the second location in a pipeline.

31. The method according to any of claim 27, wherein the method further comprises transporting solution produced by the mineralization system from the second location to the first location.

32. The method according to claim 31, where the method further comprises increasing the alkalinity of the solution produced by the mineralization system.

33. The method according to claim 32, wherein the alkalinity is increased with an alkalinity enrichment system.

34. The method according to claim 33, wherein the alkalinity enrichment system is co-located with the mineralization system.
